(19) United States
(12) Patent Application Publication
(10) Pub. No.: US 2025/0381662 A1
(43) Pub. Date: Dec. 18, 2025

(54) INFORMATION PROCESSING DEVICE, INFORMATION PROCESSING METHOD, AND PROGRAM

(71) Applicant: SONY GROUP CORPORATION, TOKYO (JP)

(72) Inventors: KIE HORIUCHI, TOKYO (JP); AKIRA FUKUI, TOKYO (JP); TOSHIHISA SAMBOMMATSU, TOKYO (JP); DAISUKE MOCHIZUKI, TOKYO (JP); MASASHI KISHIKAWA, TOKYO (JP)

(21) Appl. No.: 18/875,798

(22) PCT Filed: May 24, 2023
(86) PCT No.: PCT/JP2023/019361

§ 371 Date: Dec. 17, 2024

(30) Foreign Application Priority Data
Jun. 24, 2022 (JP) 2022-101640

(51) Int. Cl. B25J 9/16

(52) U.S. Cl. CPC B25J 9/1612; B25J 9/163

(57) ABSTRACT

There is provided a configuration that enables a robot to autonomously execute an optimal behavior matching a surrounding environment of the robot or the state of the robot itself. The configuration includes: an environment/body feature extraction unit that receives an input of a detection value of a sensor attached to a robot, and extracts at least any one feature amount of an environment feature amount that is a feature amount related to an environment around the robot, and a body feature amount that is a feature amount related to the robot itself; and a behavior control unit that determines and executes a behavior to be executed by the robot based on the extracted feature amount. For example, the configuration acquires slipperiness of a floor as the environment feature amount, and, when the floor is slippery, executes, for example, walking at a lowered walking speed, that is, determines and executes an optimal behavior that matches the feature amount.

### TECHNICAL FIELD

The present disclosure relates to an information processing device, an information processing method, and a program. More specifically, the present invention relates to an information processing device, an information processing method, and a program where a robot determines a behavior to be executed by the robot according to a surrounding environment and executes the determined behavior.

### BACKGROUND ART

In recent years, multiple so-called entertainment-type robots such as dog-type robots that react to users are used.

Most of such entertainment-type robots each have sensors and a learning function, and recognize a user's face using, for example, a camera and react to the user. Note that the robot that has the sensors and the learning function are described in, for example, PTL 1 (WO 2019/08478) and the like.

However, conventional techniques described in the above Patent Literature and the like only enable processing of determining one behavior according to, for example, a user's voice or a surrounding environment, and executing the determined behavior. For example, the robot can execute a behavior of running toward a direction of the user in response to a call from the user, yet cannot perform detailed control of grasping a situation of a floor and adjusting a running speed.

### CITATION LIST

### Patent Literature

### [PTL 1]

WO 2019/08478

### SUMMARY

### Technical Problem

With, for example, the above problem in view, an object of the present disclosure is to provide an information processing device, an information processing method, and a program that enable a robot itself to control and execute a behavior of the robot taking into account various pieces of environment information around the robot and body information of attachments or the like of the robot itself.

### Solution to Problem

A first aspect of the present disclosure is an information processing device that includes:
an environment/body feature extraction unit that receives an input of a detection value of a sensor attached to a robot, and extracts at least any one feature amount of an environment feature amount that is a feature amount related to an environment around the robot, and a body feature amount that is a feature amount related to the robot itself; and
a behavior control unit that determines and executes a behavior to be executed by the robot based on the feature amount extracted by the environment/body feature extraction unit.

Furthermore, a second aspect of the present disclosure is
an information processing method executed by an information processing device, and includes:
an environment/body feature extraction step of, at an environment/body feature extraction unit, receiving an input of a detection value of a sensor attached to a robot, and extracting at least any one feature amount of an environment feature amount that is a feature amount related to an environment around the robot, and a body feature amount that is a feature amount related to the robot itself; and
a behavior control step of, at a behavior control unit, determining and executing a behavior to be executed by the robot based on the feature amount extracted by the environment/body feature extraction unit.

Furthermore, a third aspect of the present disclosure is
a program that causes an information processing device to execute information processing, and causes:
an environment/body feature extraction unit to execute an environment/body feature extraction step of receiving an input of a detection value of a sensor attached to a robot, and extracting at least any one feature amount of an environment feature amount that is a feature amount related to an environment around the robot, and a body feature amount that is a feature amount related to the robot itself; and
a behavior control unit to execute a behavior control step of determining and executing a behavior to be executed by the robot based on the feature amount extracted by the environment/body feature extraction unit.

Note that the program according to the present disclosure is, for example, a program that can be provided by a storage medium or a communication medium provided in a computer-readable form to an information processing device or a computer system that can execute various program codes. By providing such a program in a computer-readable form, processing according to the program can be implemented on an information processing device or a computer system.

Still other objects, features, and advantages of the present disclosure will become apparent by more detailed description on the basis of the embodiment of the present disclosure and the accompanying drawings described below. Note that, in this description, the system is a logical set of configurations of a plurality of devices, and the devices having each configuration are not limited to those in the same housing.

The configuration according to one embodiment of the present disclosure implements a configuration that enables a robot to autonomously execute an optimal behavior matching a surrounding environment of the robot or a state of the robot itself.

More specifically, the configuration includes, for example, an environment/body feature extraction unit that receives an input of detection values of sensors attached to a robot, and extracts at least any one feature amount of environment feature amounts that are feature amounts related to an environment around the robot, and body feature amounts that are feature amounts related to the robot itself, and a behavior control unit that determines and executes a behavior to be executed by the robot based on the extracted feature amounts. For example, this configuration acquires slipperiness of a floor as the environment feature amount, and, when the floor is slippery, executes, for example, walking at a lowered walking speed, that is, determines and executes an optimal behavior that matches the feature amount. This configuration implements the configuration that enables the robot to autonomously execute an optimal behavior matching the surrounding environment of the robot or the state of the robot itself.

Note that the effects described in this description are merely exemplary and not limited, and may have additional effects.

### BRIEF DESCRIPTION OF DRAWINGS

FIG. 1 is a diagram for explaining an example of a dog-type robot that is an example of an information processing device according to the present disclosure.

FIG. 2 is a diagram for explaining sensors attached to the robot according to the present disclosure.

FIG. 3 is a diagram for explaining the sensors attached to the robot according to the present disclosure.

FIG. 4 is a diagram for explaining a configuration example of the robot (information processing device) according to the present disclosure.

FIG. 5 is a diagram for explaining specific examples of environment feature amounts and body feature amounts acquired from sensor detection values by an environment/body feature amount extraction unit.

FIG. 6 is a diagram for explaining specific examples of accessories that the robot can equip with.

FIG. 7 is a diagram for explaining specific examples of the environment feature amounts and the body feature amounts acquired from the sensor detection values by the environment/body feature amount extraction unit.

FIG. 8 is a diagram for explaining specific examples of the environment feature amounts and the body feature amounts acquired from the sensor detection values by the environment/body feature amount extraction unit.

FIG. 9 is a diagram for explaining a specific example of processing where the robot jumps and detects a reflected sound, hardness, and slipperiness of a floor.

FIG. 10 is a diagram for explaining a specific example of processing where the robot jumps and detects a reflected sound, hardness, and slipperiness of a floor.

FIG. 11 is a diagram for explaining types of the environment feature amounts and the body feature amounts acquired by the environment/body feature amount extraction unit by receiving an input of the sensor detection values.

FIG. 12 is a diagram for explaining types of the environment feature amounts and the body feature amounts acquired by the environment/body feature amount extraction unit by receiving an input of the sensor detection values.

FIG. 13 is a diagram for explaining the types of the environment feature amounts and the body feature amounts acquired by the environment/body feature amount extraction unit by receiving an input of the sensor detection values.

FIG. 14 is a diagram for explaining an example of behavior control of a robot 100 executed by a behavior control unit of the robot.

FIG. 15 is a diagram for explaining an example of behavior control of the robot 100 executed by the behavior control unit of the robot.

FIG. 16 is a diagram for explaining an example of behavior control of the robot 100 executed by the behavior control unit of the robot.

FIG. 17 is a diagram illustrating a flowchart for explaining a sequence of processing executed by the robot (information processing device) according to the present disclosure.

FIG. 18 is a diagram illustrating a flowchart for explaining a sequence of processing executed by the robot (information processing device) according to the present disclosure.

FIG. 19 is a diagram for explaining a specific example of processing executed by the robot according to the present disclosure.

FIG. 20 is a diagram for explaining a specific example of processing executed by the robot according to the present disclosure.

FIG. 21 is a diagram for explaining a specific example of processing executed by the robot according to the present disclosure.

FIG. 22 is a diagram for explaining a specific example of processing executed by the robot according to the present disclosure.

FIG. 23 is a diagram for explaining a specific example of processing executed by the robot according to the present disclosure.

FIG. 24 is a diagram for explaining a configuration example of the robot (information processing device) according to the present disclosure.

FIG. 25 is a diagram for explaining a configuration example of the robot (information processing device) according to the present disclosure.

FIG. 26 is a diagram for explaining a configuration example of the robot (information processing device) according to the present disclosure.

FIG. 27 is a diagram for explaining a specific example of processing executed by the robot according to the present disclosure.

FIG. 28 is a diagram for explaining a specific example of processing executed by the robot according to the present disclosure.

FIG. 29 is a diagram for explaining a specific example of processing executed by the robot according to the present disclosure.

FIG. 30 is a diagram for explaining a specific example of processing executed by the robot according to the present disclosure.

FIG. 31 is a diagram for explaining a specific example of processing executed by the robot according to the present disclosure.

FIG. 32 is a diagram for explaining a specific example of processing executed by the robot according to the present disclosure.

FIG. 33 is a diagram for explaining a hardware configuration example of the robot (information processing device) according to the present disclosure.

### DESCRIPTION OF EMBODIMENTS

Hereinafter, the details of an information processing device, an information processing method, and a program according to the present disclosure will be described with reference to the drawings. Note that explanation will be given according to the following items.
1. Configuration of robot that is information processing device according to present disclosure and attachment sensors
2. Configuration example of robot (information processing device) according to present disclosure
2-1. Details and specific examples of processing executed by environment/body feature extraction unit
2-2. Details and specific examples of processing executed by behavior control unit
3. Sequence of processing executed by robot (information processing device) according to present disclosure
4. Other configuration example of robot (information processing device) according to present disclosure
5. Specific examples of processing that uses robot (information processing device) according to present disclosure
6. Hardware configuration example of robot (information processing device) according to present disclosure
7. Summary of configuration of present disclosure

### 1. CONFIGURATION OF ROBOT THAT IS INFORMATION PROCESSING DEVICE ACCORDING TO PRESENT DISCLOSURE AND ATTACHMENT SENSORS

First, the configuration of the robot that is the information processing device according to the present disclosure and the attachment sensors will be described.

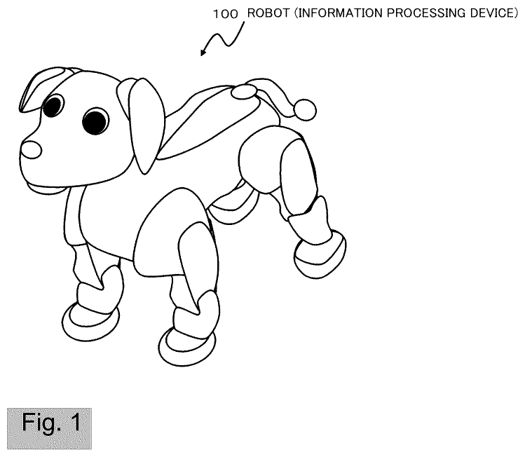

FIG. 1 illustrates an example of a dog-type robot that is an example of the information processing device according to the present disclosure.

A robot (information processing device) 100 illustrated in FIG. 1 is the dog-type robot, and is a so-called entertainment-type robot that interacts with users.

The robot (information processing device) 100 illustrated in FIG. 1 is a robot that autonomously moves, for example, that is, autonomously executes a behavior. The robot 100 executes an action according to a user's instruction in response to, for example, a user's speech or the like. When sensors (a camera and microphones) attached to the robot 100 detect user's call or beckoning, the robot 100 executes an autonomous behavior of running close to the user.

Furthermore, the robot can also control a facial expression of the face. When, for example, the sensor (camera) detects user's smile, the robot 100 can also perform feeling expression of showing a smiling facial expression.

Note that, for example, eyes of the robot 100 are configured as, for example, displays such as liquid crystal displays, and can display various eyes associated with various feelings such as the eyes corresponding to smile, sad eyes, and angry eyes.

A data processing unit in the robot 10 receives an input of detection information of the various sensors attached to the robot 100, and determines what behavior, that is, what action or feeling expression (presentation) to execute using the input detection information of the sensors.

Note that the “behavior” of the robot 100 in this description includes both of an “action” of the robot and “feeling expression (presentation)” of the robot 100.

The data processing unit in the robot 100 uses a machine learning algorithm such as deep learning to determine an optimal behavior mode matching a surrounding environment (situation), a body situation of the robot such as an equipment situation of accessories, or loads (such as torques) of joint parts.

Note that the robot 100 employs a configuration that enables equipment of various accessories such as clothes, shoes, and sole pads. Specific examples of these accessories will be described later.

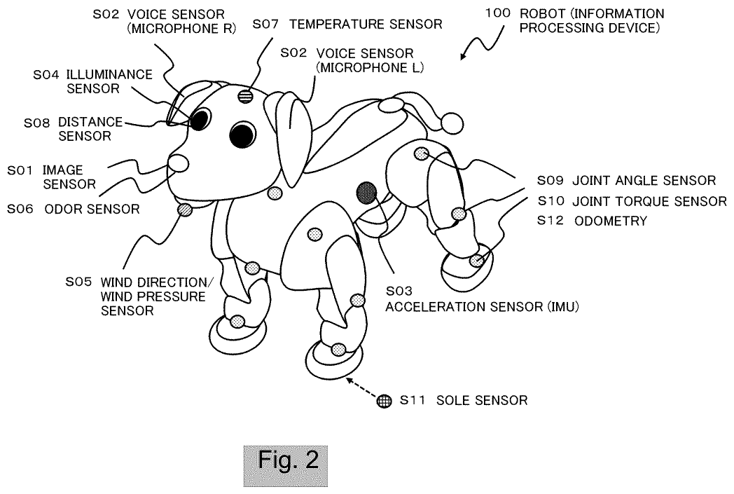

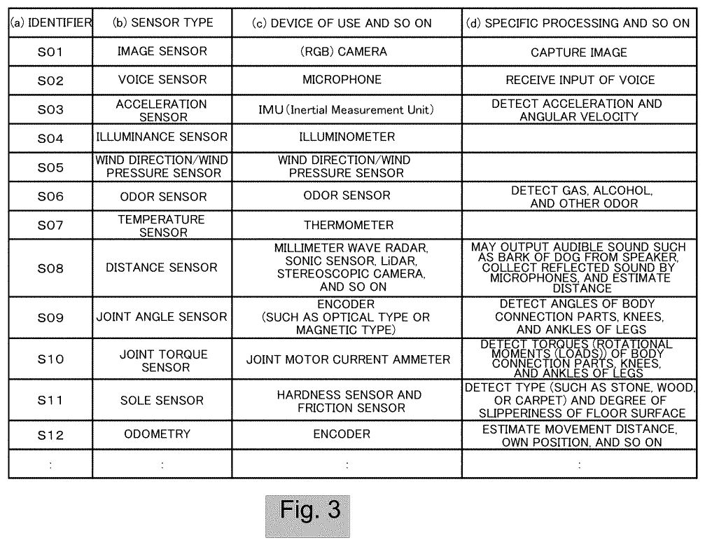

The sensors attached to the robot 100 will be described with reference to FIGS. 2 and 3.

As illustrated in FIG. 2, the various sensors are attached to the robot 100.

Note that FIG. 3 is a diagram for explaining details of the sensors illustrated in FIG. 2.

As illustrated in FIGS. 2 and 3, for example, the following sensors are attached to the robot 100.
S01: Image sensor
S02: Voice sensor
S03: Acceleration sensor
S04: Illuminance sensor
S05: Wind direction/wind pressure sensor
S06: Odor sensor
S07: Temperature sensor
S08: Distance sensor
S09: Joint angle sensor
S10: Joint torque sensor
S11: Sole sensor
S12: Odometry

Note that these sensors illustrated in FIGS. 2 and 3 are examples of the sensors attached to the robot 100, and a configuration may be employed where other types of sensors are attached.

The sensors illustrated in FIGS. 2 and 3 will be sequentially described.

The image sensor S01 includes, for example, an RGB camera, and captures images. For example, the image sensor S01 is attached to a nose part of the robot 100 as illustrated in FIG. 2. Basically, the image sensor S01 continuously captures moving images.

Note that, although FIG. 2 illustrates only the one image sensor S01, there may be employed a configuration including a plurality of cameras that individually photograph a front/rear/left/right and upper/lower directions of the robot 100.

More specifically, the voice sensors S02 are microphones that acquire voices. For example, the voice sensors S02 are attached to ear parts of the robot 100 as illustrated in FIG. 2.

Note that, although FIG. 2 illustrates the two voice sensors S02 at the left and right ears, one microphone may be used or a configuration including three or more microphones may be employed.

The acceleration sensor S03 detects a motion of the robot such as an acceleration, an angular acceleration, vibration, and the like. The acceleration sensor S03 is attached to a belly part of the robot 100 as illustrated in, for example, FIG. 2. More specifically, for example, an Inertial Measurement Unit (IMU) is used.

The illuminance sensor S04 detects brightness around the robot 100. The illuminance sensor S04 is attached to an eye part of the robot 100 as illustrated in, for example, FIG. 2.

The wind direction/wind pressure sensor S05 detects a wind direction and a wind strength. The wind direction/wind pressure sensor S05 is attached to a mouth part of the robot 10 as illustrated in, for example, FIG. 2.

The odor sensor S06 detects an odor around the robot 100. The odor sensor S06 is attached to a nose part of the robot 100 as illustrated in, for example, FIG. 2. The odor sensor S06 includes devices that detect various odors such as a gas odor and an alcohol odor.

The temperature sensor S07 detects the temperature around the robot 100. The temperature sensor S07 is attached to a head part of the robot 100 as illustrated in, for example, FIG. 2.

The distance sensor S08 detects distances to various objects around the robot 100. The distance sensor S08 is attached to the eye part of the robot 10 as illustrated in, for example, FIG. 2.

The distance sensor S08 is configured as, for example, a millimeter wave radar, a sonic sensor, a Light Detection and Ranging or Laser Imaging Detection and Ranging (LiDAR), a Time of Flight (ToF) sensor, a stereoscopic camera, and the like.

In a case where the sonic sensor is used, by outputting a bark of the dog from the speaker of the robot 100, receiving an input of a reflected wave of the bark by the microphones, and analyzing a microphone input signal, it is possible to analyze a distance to and a direction of an object that has reflected the output voice.

The joint angle sensors S09 are attached to body connection parts, knee parts, and ankle parts of leg parts of the robot 100, a neck part of a head side, and the like, and detect angles of these joint parts. The joint angle sensors S09 are configured as, for example, optical encoders, magnetic encoders, or the like.

The joint torque sensors S10 are attached to the body connection parts, the knee parts, the ankle parts of the leg parts of the robot 100, the neck part of the head side, and the like, and detect torques (rotational moments (loads)) of these joint parts. For example, measuring instruments of joint motor current value or the like are used.

The sole sensors S11 are configured as a hardness sensor or a friction sensor, and detects an object that the robot 100 contacts such as hardness of a floor on which the robot 100 stands or a friction of the floor.

The sole sensors S11 are attached to, for example, soles of the legs of the robot 100 as illustrated in FIG. 2. More specifically, the sole sensors S11 detect, for example, whether the floor is made of a stone material such as a marble or is made of a wood material such as a wooden floor, whether or not a carpet is laid down, or whether or not the robot 100 is on a sofa or a futon. Furthermore, the sole sensors S11 detect, for example, whether or not the floor is slippery.

The odometries S12 are attached to the body connection parts, the knee parts, the ankle parts, and the like of the leg parts of the robot 100. The odometries S12 are, for example, encoders, and detect the motion of each joint part and estimate a movement distance of the robot 10 or an own position of the robot.

Note that, as described above, the sensors illustrated in FIGS. 2 and 3 are the examples of the sensors attached to the robot 100, and the configuration may be employed where other types of sensors are attached.

### 2. CONFIGURATION EXAMPLE OF ROBOT (INFORMATION PROCESSING DEVICE) ACCORDING TO PRESENT DISCLOSURE

Next, the configuration example of the robot (information processing device) according to the present disclosure will be described.

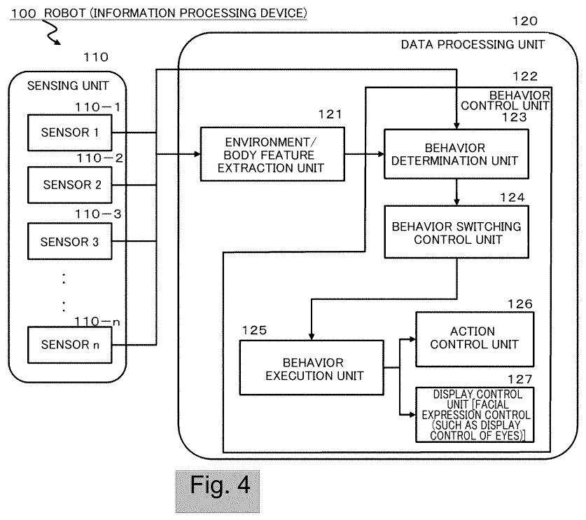

FIG. 4 is a diagram illustrating a configuration example of the robot (information processing device) 100 according to the present disclosure.

As illustrated in FIG. 4, the robot (information processing device) 100 according to the present disclosure includes a sensing unit 110 and a data processing unit 120.

The sensing unit 110 includes the various sensors described with reference to FIGS. 2 and 3, and collects information on a surrounding environment.

As illustrated in FIG. 4, the data processing unit 120 includes an environment/body feature extraction unit 121 and a behavior control unit 122.

The behavior control unit 122 includes a behavior determination unit 123, a behavior switching control unit 124, a behavior execution unit 125, an action control unit 126, and a facial expression control unit 127.

The environment/body feature amount extraction unit 121 receives an input of various items of sensor detection data from the sensing unit 110, and extracts feature amounts of an environment around the robot and body feature amounts of the robot itself using a machine learning model based on the input data.

The environment feature amounts include various pieces of environment information such as information related to objects around the robot, material quality and hardness of a running surface (floor surface) of the robot, a time, a temperature, a user's state (smiling, angry, or the like), and a noisy state. Specific examples of these environment feature amounts will be described later.

The body feature amounts of the robot itself are feature amounts indicating whether or not accessories such as clothes, shoes, and sole pads that the robot can equip with are equipped, a driving unit of the robot, and a situation of loads (torques) of, for example, the joint parts of the legs, a battery status, and the like. Specific examples of these body feature amounts will be also described later.

Next, the behavior control unit 122 will be described.

The behavior control unit 122 controls a behavior to be executed by the robot 100. As described above, the “behavior” of the robot 100 in this description includes both of an “action” of the robot 100 and “feeling expression (presentation)” of the robot 100.

The behavior control unit 122 controls at least any one of the “action” to be executed by the robot 100 and “feeling expression (presentation)” to be executed by the robot 100 according to the feature amounts of the environment around the robot or the body feature amounts of the robot itself.

As illustrated in FIG. 4, the behavior control unit 122 includes the behavior determination unit 123, the behavior switching control unit 124, the behavior execution unit 125, the action control unit 126, and the facial expression control unit 127.

Hereinafter, processing executed by each of these components will be described.

The behavior determination unit 123 determines a behavior to be executed in response to a sensor input of the sensing unit 110, a user's action input via, for example, an image sensor (camera), or a user's voice input via voice sensors (microphones).

Furthermore, the behavior determination unit 123 also performs processing of determining the behavior to be executed by the robot 100 according to the feature amounts of the environment around the robot and the body feature amounts of the robot itself extracted by the environment/body feature amount extraction unit 121.

The behavior determination unit 123 receives an input of a surrounding environment (situation), a body situation of the robot such as an equipment situation of accessories, or a load (such as a torque) of each joint part, applies the machine learning algorithm such as deep learning, and determines an optimal behavior mode matching the current environment or the body situation.

Note that, as described above, the “behavior” of the robot 100 in this description includes both of an “action” of the robot and “feeling expression (presentation)” of the robot 100.

That is, the behavior determination unit 123 determines at least any one of the “action” to be executed by the robot 100 and “feeling expression (presentation)” to be executed by the robot 100 according to the feature amounts of the environment around the robot or the body feature amounts of the robot itself.

Note that the behavior determination unit 123 performs processing of determining whether or not there is a behavior that needs to be executed to acquire valid or necessary sensor detection values from the sensing unit 110, and determining this behavior as a behavior that needs to be executed in a case where there is such a behavior.

As described above, the processing of executing the behavior for acquiring the sensor detection values and acquiring the sensor detection values will be referred to as active sensor detection value acquisition processing.

More specifically, when, for example, the user's face is on the left side and the robot needs to check a facial expression of the user's face, the behavior determination unit 123 determines a behavior for directing the direction of the face of the robot 10, that is, the direction of the camera that is the sensor to the direction of the user's face as a behavior that needs to be executed, and causes the behavior execution unit 125 to execute the behavior.

This processing makes it possible to acquire an image of the user's face using the image sensor (camera).

Furthermore, when, for example, illuminance is low like at night and a captured image of the camera is unclear, the behavior determination unit 123 determines a behavior for causing a light attached to the robot 100 to emit light as a behavior that needs to be executed, and causes the behavior execution unit 125 to execute the behavior.

This processing makes it possible to acquire a bright face image using the image sensor (camera).

Furthermore, when, for example, the robot 100 tries to run on a floor, the behavior determination unit 123 determines a behavior of stomping by shaking the legs of the robot up and down to check whether, for example, the floor is hard or slippery as a behavior that needs to be executed, and causes the behavior execution unit 125 to execute the behavior.

This processing makes it possible to acquire information such as whether the floor is hard or slippery using the sole sensors.

As described above, the behavior determination unit 123 also performs processing of determining a behavior for acquiring valid or necessary sensor detection values from the sensing unit 110 as a behavior that needs to be executed.

The behavior switching control unit 124 determines whether or not the behavior determined by the behavior determination unit 123 and a currently executed behavior are different, and outputs behavior mode information that needs to be switched and a behavior switching request to the behavior execution unit 125 when the behaviors are different.

The behavior execution unit 125 controls execution of various behaviors of the robot 100. More specifically, the behavior execution unit 125 controls the driving unit 126 and the display control unit 127 to control the action or the facial expression of the robot 10.

Note that, when receiving an input of the behavior mode information that needs to be switched and the behavior switching request from the behavior switching control unit 124, the behavior execution unit 125 executes processing of switching the behavior of the robot 100 according to input information.

The driving unit 126 includes driving mechanisms such as a motor and an actuator for moving various component parts such as the leg parts, the neck, the body, and the tail of the robot 100, and executes driving processing for implementing the motion of the robot according to an instruction of the behavior execution unit.

The display control unit 127 controls, for example, images of eyes output to displays at eye parts of the face of the robot. By performing this control, the display control unit 127 can change the facial expression of the robot to various states. The display control unit 127 executes display control processing for embodying a facial expression of the robot such as a happy facial expression, a smiling facial expression, a sad facial expression, a perplexed facial expression, and an angry facial expression matching an instruction of the behavior execution unit.

Next, specific processing examples of components of the data processing unit 120 illustrated in FIG. 4, that is, these environment/body feature extraction unit 121 and behavior control unit 122 will be described.

### (2-1. Details and Specific Examples of Processing Executed by Environment/Body Feature Extraction Unit)

First, details and the specific examples of processing executed by the environment/body feature extraction unit 121 of the data processing unit 120 of the robot (information processing device) 100 illustrated in FIG. 4 will be described.

As described above, the environment/body feature amount extraction unit 121 receives an input of various items of sensor detection data from the sensing unit 110, and extracts the feature amounts of the environment around the robot and the body feature amounts of the robot itself using the machine learning model based on the input data.

Note that the environment/body feature amount extraction unit 121 also executes not only processing of passively receiving an input of sensor detection values detected by the sensors of the sensing unit 110, but also active sensor detection value input processing as processing of receiving an input of the sensor detection values from the sensing unit 110.

The active sensor detection value input processing is processing where the robot 100 executes a specific behavior to obtain specific sensor detection values, and acquires sensor detection values that become necessary as a result of the behavior.

As described earlier, the behavior determination unit 123 determines a behavior for acquiring valid or necessary sensor detection values from the sensing unit 110 as a behavior that needs to be executed, and causes the behavior execution unit 125 to execute this behavior.

The environment/body feature extraction unit 121 also executes processing of acquiring active sensor detection values as a result of such a behavior.

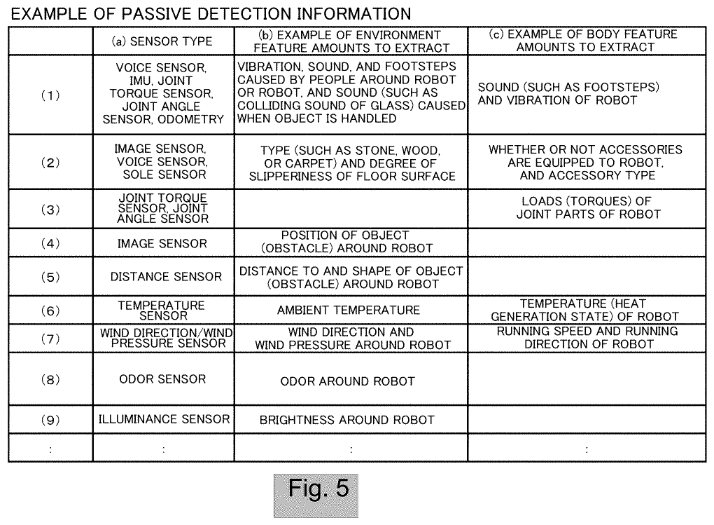

Specific examples of the environment feature amounts and the body feature amounts acquired from the input sensor detection values by the environment/body feature amount extraction unit 121 by receiving an input of the sensor detection values from the sensing unit 110 will be described with reference to FIG. 5 and subsequent drawings.

FIG. 5 illustrates an example of passive detection information.

FIG. 5 illustrates a table in which
(a) Sensor type (sensor to use),
(b) Example of environment feature amounts to extract, and
(c) Example of body feature amounts to extract are associated.

An entry (1) in FIG. 5 indicates examples of following passive detection information.
(a) Sensor type (sensor to use)=voice sensors, IMU, joint torque sensors, joint angle sensors, and odometries,
(b) Example of environment feature amounts to extract=people around robot, vibration, sound, and footsteps caused by robot, and sound (such as colliding sound of glass) caused at time when object is handled, and
(c) Example of body feature amounts to extract=sound of robot (such as footsteps)

This passive detection information example (1) indicates that, when receiving an input of detection information of at least any one sensor of the voice sensors, the IMU, the joint torque sensors, the joint angle sensors, and the odometries, the environment/body feature amount extraction unit 121 extracts as the environment feature amount at least any one of these environment feature amounts of people around the robot, vibration, sound, and footsteps caused by the robot, and the sound (such as a colliding sound of glass) caused at a time when an object is handled, and extracts as the body feature amount at least any one of a sound (such as footsteps) and vibration of the robot.

A next passive detection information example (2) indicates that, when receiving an input of detection information of at least one sensor of the image sensor, the voice sensors, and the sole sensors,
the environment/body feature amount extraction unit 121 extracts the type (such as a stone, a wood, or a carpet) of a floor surface or the degree of slipperiness of the floor, and
extracts whether or not accessories are equipped to the robot and equipped accessory type as the body feature amounts.

Note that, as described above, the robot 100 employs a configuration that enables equipment of the various accessories such as clothes, shoes, and sole pads.

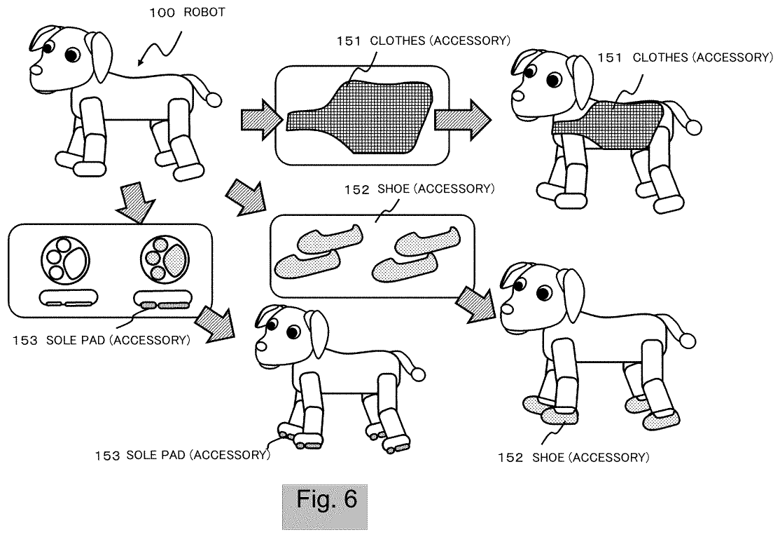

Specific examples of the accessories that the robot 100 can equip with will be described with reference to FIG. 6.

As illustrated in FIG. 6, the robot 100 can be equipped with the various accessories such as clothes 151, shoes 152, and sole pads 153.

The shoes 152 and the sole pads 153 provide an effect of slip prevention or noise prevention when the robot 100 walks or runs.

Data (2) illustrated in FIG. 5 indicates that the environment/body feature amount extraction unit 121 receives an input of the detection information of one sensor of the image sensor, the voice sensors, and the sole sensors, and determines whether or not the robot 100 is equipped with the accessories such as the shoes or the sole pads.

For example, the environment/body feature amount extraction unit 121 executes processing of determining whether or not the robot 100 is equipped with the accessories such as the shoes or the sole pads based on images of the legs of the robot 100, or processing of determining whether or not the robot 100 is equipped with the accessories such as the shoes or the sole pads based on footsteps caused at a time when the robot 100 walks.

Data of passive detection information examples (3) to (9) illustrated in FIG. 5 is as follows.

The passive detection information example (3) indicates that the environment/body feature amount extraction unit 121 receives an input of detection information of one sensor of the joint torque sensors and the joint angle sensors, and extracts loads (such as torques) of the joints of the robot as the body feature amounts.

The passive detection information example (4) indicates that the environment/body feature amount extraction unit 121 receives an input of detection information of the image sensor, and extracts positions of objects (obstacles) around the robot as the body feature amounts.

The passive detection information example (5) indicates that the environment/body feature amount extraction unit 121 receives an input of detection information of the distance sensor, and extracts distances to and the shapes of the objects (such as the objects) around the robot as the environment feature amounts.

The passive detection information example (6) indicates that the environment/body feature amount extraction unit 121 receives an input of detection information of the temperature sensor, extracts the temperature in the surroundings as the environment feature amount, and extracts the temperature (heat generation state) of the robot as the body feature amount.

The passive detection information example (7) indicates that the environment/body feature amount extraction unit 121 receives an input of detection information of the wind direction/wind pressure sensor, extracts a wind direction and a wind pressure around the robot as the environment feature amounts, and extracts a running speed and a running direction of the robot as the body feature amounts.

The passive detection information example (8) indicates that the environment/body feature amount extraction unit 121 receives an input of detection information of the odor sensor, and extracts an odor around the robot as the environment feature amount.

The passive detection information example (9) indicates that the environment/body feature amount extraction unit 121 receives an input of detection information of the illuminance sensor, and extracts brightness around the robot as the environment feature amount.

As described above, the environment/body feature amount extraction unit 121 receives an input of the various sensor detection values from the sensing unit 110, and acquires the various environment feature amounts and body feature amounts from the input sensor detection values.

The example of the feature amount extraction processing of the environment/body feature amount extraction unit 121 described with reference to FIG. 5 is a processing example where the environment/body feature amount extraction unit 121 passively receives an input of the various sensor detection values from the sensing unit 110, and acquires the environment feature amounts and body feature amounts.

As described above, the environment/body feature amount extraction unit 121 executes not only processing of passively receiving an input of the sensor detection values detected by the sensors of the sensing unit 110, and but also active sensor detection value input processing where the robot 100 executes a specific behavior to obtain specific sensor detection values, and acquires sensor detection values that become necessary as a result of this behavior.

For example, the behavior determination unit 123 determines a behavior for acquiring valid or necessary sensor detection values from the sensing unit 110 as a behavior that needs to be executed, and causes the behavior execution unit 125 to execute this behavior. The environment/body feature extraction unit 121 also executes processing of acquiring active sensor detection values as a result of such a behavior.

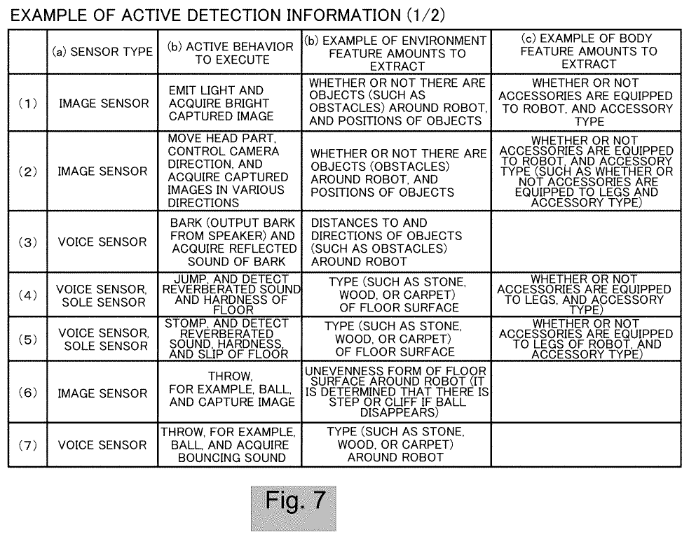

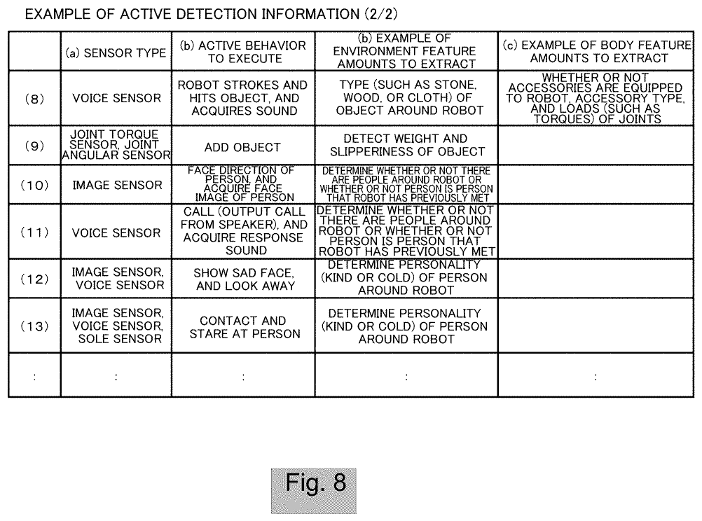

Specific examples of processing of executing active sensor detection value input processing, that is, active sensor detection value input processing where the robot 100 executes a specific behavior to obtain specific sensor detection values and acquires sensor detection values that become necessary as a result of this behavior, and acquires the environment feature amounts and the body feature amounts will be described with reference to FIGS. 7 and 8.

FIGS. 7 to 8 illustrate examples of the active detection information.

FIGS. 7 and 8 illustrate tables in which
(a) Sensor type (sensor to use),
(b) Active behavior to execute,
(c) Example of environment feature amounts to extract, and
(d) Example of body feature amounts to extract
are associated.

An entry (1) in FIG. 7 indicates examples of following active detection information.
(a) Sensor type (sensor to use)=image sensor,
(b) Active behavior to execute=emit light and acquire bright captured image,
(c) Example of environment feature amounts to extract=whether or not there are objects (obstacles) around robot, and positions of objects, and
(d) Example of body feature amounts to extract=whether or not accessories are equipped to robot and accessory type

This active detection information example (1) indicates that, when using the image sensor, the environment/body feature amount extraction unit 121 emits light,
acquires a captured image,
extracts whether or not there are objects (obstacles) around the robot and the positions of the objects as the environment feature amounts, and
extracts whether or not the accessories are equipped to the robot and the accessory type as the body feature amounts.

Note that the light is the light attached to the robot 100, and emits light under control of the behavior execution unit 125.

A next active detection information example (2) indicates that, when using the image sensor, the environment/body feature amount extraction unit 121 moves the head part, controls a camera direction, acquires captured images of various directions, extracts whether or not there are the objects (obstacles) around the robot and the positions of the objects as the environment feature amounts, and extracts whether or not the accessories are equipped to the robot and the accessory type as the body feature amounts.

By, for example, directing toward the legs the head part to which the image sensor (camera) has been attached to capture images of the legs, and capturing the images of the legs, it is possible to check whether or not the accessories such as the shoes and the sole pads are equipped to the legs of the robot.

Data of active detection information examples (3) to (7) illustrated in FIG. 7 is as follows.

The active detection information example (3) indicates that, when using the voice sensors, the environment/body feature amount extraction unit 121 outputs a barking action, that is, a barking voice through the speaker, acquires a reflected sound of the barking voice, and acquires distances to and directions of the objects (obstacles) around the robot as the environment feature amounts.

The active detection information example (4) indicates that, when using the voice sensors or the sole sensors, the environment/body feature amount extraction unit 121 causes the robot to jump, detects the reflected sound, hardness, and slipperiness of the floor, identifies the type (such as a stone, a wood, or a carpet) of the floor surface as the environment feature amount, and extracts whether or not the accessories are equipped to the legs of the robot and the equipped accessory type as the body feature amounts.

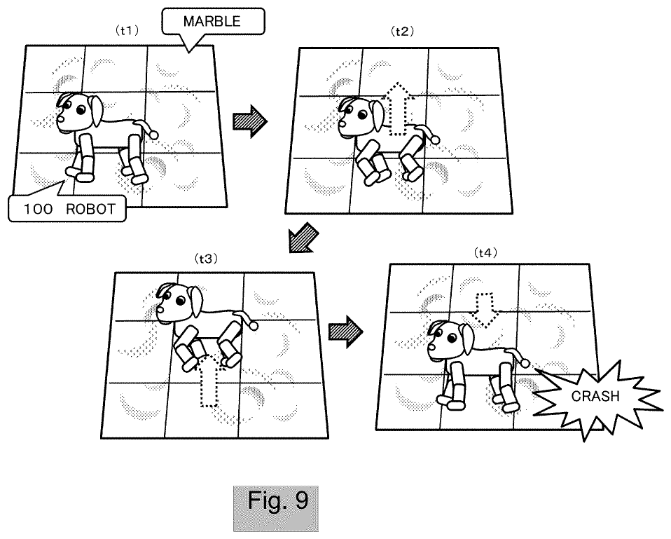

A specific example of this processing will be described with reference to FIG. 9.

FIG. 9 illustrates the processing example where the robot 100 jumps.

The robot 100 stands on a marble floor at a time (t1).

The robot 100 transitions to a jumping system at a next time (t2), jumps at (t3), and lands at (t4).

At the time of landing at the time (t4), the legs of the robot 100 and the marble floor collide and cause a loud colliding sound (crash).

The voice sensors (microphones) of the robot 100 acquire this loud colliding sound, and inputs the colliding sound to the environment/body feature amount extraction unit 121.

The environment/body feature amount extraction unit 121 acquires a feature amount indicating that the type of the floor surface is the stone as the environment feature amount based on the loud colliding sound input from the voice sensors (microphones). Furthermore, the environment/body feature amount extraction unit 121 acquires a feature amount indicating that the shoes or the sole pads are not equipped to the legs of the robot as the body feature amount.

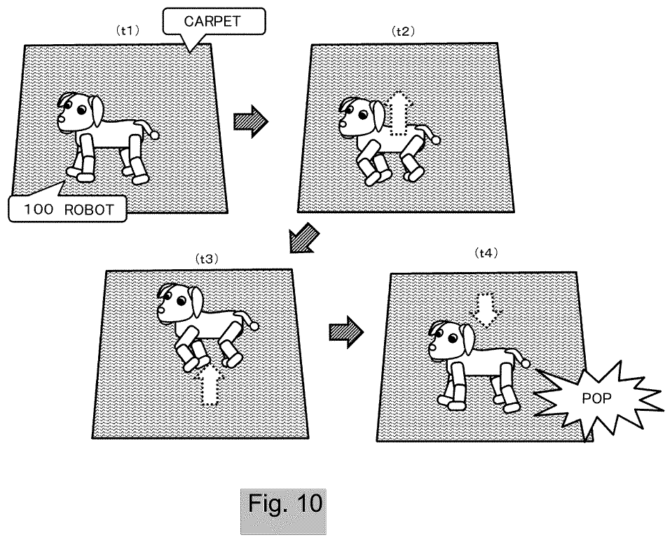

FIG. 10 illustrates a processing example where the floor is a soft “carpet”.

The robot 100 stands on a carpet floor at the time (t1).

The robot 100 transitions to a jumping system at the next time (t2), jumps at (t3), and lands at (t4).

At the time of landing at the time (t4), the legs of the robot 100 and the carpet collide and cause a light colliding sound (pop).

The voice sensors (microphones) of the robot 100 acquire this light colliding sound, and inputs the colliding sound to the environment/body feature amount extraction unit 121.

The environment/body feature amount extraction unit 121 acquires a feature amount indicating that the type of the floor surface is the carpet as the environment feature amount based on the light colliding sound input from the voice sensors (microphones). Furthermore, the environment/body feature amount extraction unit 121 acquires a feature amount indicating that the shoes or the sole pads are not equipped to the legs of the robot as the body feature amount.

Back to FIG. 7, other active detection information examples will be described. The active detection information example (5) indicates that, when using the voice sensors or the sole sensors, the environment/body feature amount extraction unit 121 causes the robot to stomp without causing the robot to jump, detects the reflected sound and hardness of the floor, identifies the type (such as a stone, a wood, or a carpet) of the floor surface as the environment feature amount, and extracts whether or not the accessories are equipped to the legs of the robot and the equipped accessory type as the body feature amounts.

The active detection information example (6) indicates a processing example where, when using the image sensor, the environment/body feature amount extraction unit 121 capture an image by throwing a ball, and acquires unevenness information of the floor surface around the robot as the environment feature amount.

When the ball disappears from the image, the environment/body feature amount extraction unit 121 determines that the floor has a step or a “cliff”.

The active detection information example (7) indicates a processing example where, when using the voice sensors, the environment/body feature amount extraction unit 121 acquires a bouncing sound by throwing a ball, and acquires information of the type (such as a stone, a wood, or a carpet) of the floor surface around the robot as the environment feature amount.

For example, the environment/body feature amount extraction unit 121 determines that the floor type is “a stone such as a marble” in a case of a hard sound, and is a “carpet” in a case of a soft sound.

In the active detection information example (8) illustrated in FIG. 8, when using the voice sensors, the environment/body feature amount extraction unit 121 performs processing where the robot strokes or hits an object, and acquires this stroking or hitting sound. The active detection information example (8) indicates that the environment/body feature amount extraction unit 121 acquires material information on types (such as stones, woods, or cloths) of objects around the robot as the environment feature amount from the sound obtained by this processing, and extracts whether or not the accessories are equipped to the robot, the accessory type, loads (such as torques) of the joints, and the like as the body feature amounts.

In the active detection information example (9), when using the joint torque sensors or the joint angle sensors, the environment/body feature amount extraction unit 121 causes the robot to add an object thereto. The environment/body feature amount extraction unit 121 acquires the weight and slipperiness of the added object as the environment feature amounts based on information on, for example, a joint torque and a joint angle of the neck of the robot obtained by this processing.

In the active detection information example (10), when using the image sensor, the environment/body feature amount extraction unit 121 captures a face image of a person by facing a direction of the person. Whether or not the person is a person that the robot has previously met is determined from the face image of the person obtained by this processing.

Note that, when this processing is executed, the robot 100 acquires a past captured image from a database in which previously captured face images have been stored, and performs processing of cross-checking the past captured image and the captured image.

In the active detection information example (11), when using the voice sensors, the environment/body feature amount extraction unit 121 executes processing of calling a person. That is, the environment/body feature amount extraction unit 121 outputs a calling sound via the speaker. The environment/body feature amount extraction unit 121 determines from a response voice of the person obtained by this processing whether or not there are people around the robot, and whether or not the person is a person that the robot has previously met.

Note that, when this processing is executed, too, the robot 100 acquires a past spoken voice from a database in which previously acquired spoken voices of the person have been stored, and performs processing of cross-checking the past spoken voice and the spoken voice.

In the active detection information example (12), when using the image sensor or the voice sensors, the environment/body feature amount extraction unit 121 takes an action of showing a sad facial expression or looking way. The environment/body feature amount extraction unit 121 determines the personality of this person, that is, whether this person is, for example, kind or cold from a reaction of the person, that is, the face image or the response voice obtained by this processing.

In the active detection information example (13), when using the image sensor, the voice sensors, and the sole sensors, the environment/body feature amount extraction unit 121 takes an action of touching and starting at the person. The environment/body feature amount extraction unit 121 determines the personality of this person, that is, whether this person is, for example, kind or cold from a reaction of the person, that is, the face image, the response voice, or the way of stroking obtained by this processing.

As described above, the environment/body feature amount extraction unit 121 performs processing of receiving and analyzing an input of the sensor detection values input from the sensors of the sensing unit 110 as a result obtained by performing various behaviors, and acquiring the various environment feature amounts and body feature amounts.

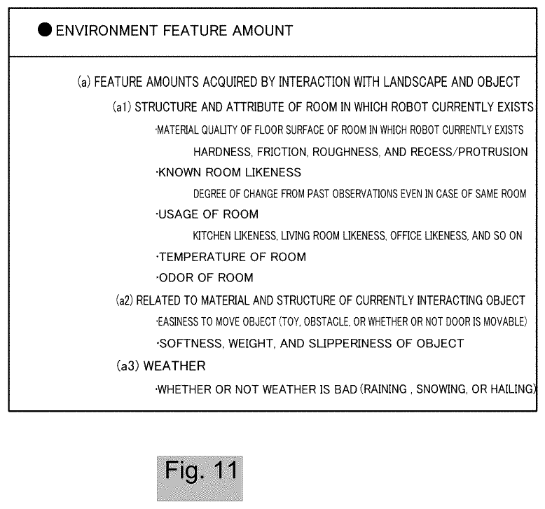

Next, types of the environment feature amounts and the body feature amounts acquired by the environment/body feature amount extraction unit 121 by receiving an input of the detection values of the sensors of the sensing unit 110 will be described with reference to FIGS. 11 to 13.

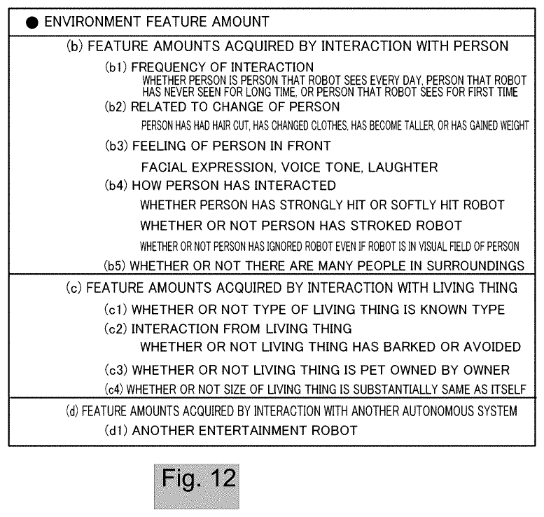

First, the types of the environment feature amounts acquired by the environment/body feature amount extraction unit 121 by receiving an input of the detection values of the sensors of the sensing unit 110 will be described with reference to FIGS. 11 and 12.

As illustrated in FIGS. 11 to 12, examples of the environment feature amounts acquired by the environment/body feature amount extraction unit 121 by receiving an input of the detection values of the sensors of the sensing unit 110 include following feature amounts.
(a) Feature amounts acquired by interaction with landscape and object
(b) Feature amounts acquired by interaction with person
(c) Feature amounts acquired by interaction with living thing
(d) Feature amounts acquired by interaction with another autonomous system

“(a) feature amounts acquired by interaction with landscape and object” are environment feature amounts that are acquired based on a sensor detection value associated with a landscape or an object such as the land scape in the space such as a room in which the robot 100 exists or an image associated with the landscape in this space. More specifically, examples of “(a) feature amounts acquired by interaction with landscape and object” include following environment feature amounts.
(a1) Environment feature amounts related to structure and attribute of room in which robot currently exists
(a2) Environment feature amounts related to material and structure of currently interacting object
(a3) Environment feature amounts related to weather

More specifically, examples of “(a1) environment feature amounts related to structure and attribute of room in which robot currently exists” include following environment feature amounts.
Material quality of floor surface of room in which robot currently exists=hardness, friction, roughness, and recess/protrusion
Known room likeness=degree of change from past observations and so on even in case of same room
Usage of room=kitchen likeness, living room likeness, office likeness, and so on
Temperature of room
Odor of room

For example, “(a1) environment feature amounts related to structure and attribute of room in which robot currently exists” include these environment feature amounts.

Furthermore, more specifically, examples of “(a2) environment feature amounts related to material and structure of currently interacting object” include following environment feature amounts.
Easiness to move object=for example, toy, obstacle, and whether or not door is movable
Softness, weight, and slipperiness of object

Furthermore, more specifically, examples of “(a3) environment feature amounts related to weather” include following environment feature amount.
Whether weather is good or bad=whether weather is sunny, cloudy, rainy, snowy, or hailing

“(b) feature amounts acquired by interaction with person” include environment feature amounts acquired based on sensor detection values associated with a person detected by the robot 100. More specifically, examples of “(b) feature amounts acquired by interaction with person” include following environment feature amounts.
(b1) Frequency of interaction

For example, whether the person is a person that the robot sees every day, is a person that the robot has never seen for a long time, or a person that the robot sees for the first time
(b2) Related to change of person

For example, the person has had hair cut, has changed clothes, has become taller, or has gained weight.
(b3) Feeling of person in front

For example, a facial expression, a voice tone, and a laughter
(b4) How person has interacted

For example, whether the person has strongly hit, softly hit, stroked, or ignored the robot even if the robot is in the visual field of the person.
(b5) Whether or not there are many people in surroundings

Furthermore, “(c) feature amounts acquired by interaction with living thing” include environment feature amounts acquired based on sensor detection values associated with living things such as a dog or a cat that are living things other than people detected by the robot 100. More specifically, examples of “(c) feature amounts acquired by interaction with living thing” include following environment feature amounts.
(c1) Whether or not type of living thing is known type
(c2) Interaction from living thing

For example, whether the living thing has barked or avoided
(c3) Whether or not living thing is pet owned by owner
(c4) Whether or not size of living thing is substantially same as that of itself

Furthermore, “(d) feature amounts acquired by interaction with another autonomous system” include environment feature amounts acquired based on sensor detection values associated with another autonomous system such as another robot detected by the robot 100. More specifically, examples of “(d) feature amounts acquired by interaction with another autonomous system” include following environment feature amounts.
(d1) Feature amounts acquired by interaction such as conversation with another entertainment robot

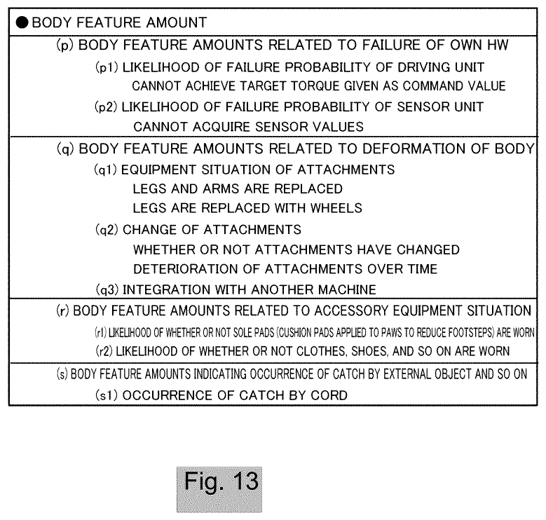

Next, types of the body feature amounts acquired by the environment/body feature amount extraction unit 121 by receiving an input of the detection values of the sensors of the sensing unit 110 will be described with reference to FIG. 13.

As illustrated in FIG. 13, examples of the body feature amounts acquired by the environment/body feature amount extraction unit 121 by receiving an input of the detection values of the sensors of the sensing unit 110 include following feature amounts.
(p) Body feature amounts related to failures of own HardWare (HW)
(q) Body feature amounts related to deformation of body
(r) Body feature amounts related to accessory equipment situation
(s) Body feature amounts such as occurrence of catch by external object and so on

“(p) body feature amounts related to failures of own HardWare (HW)” are body feature amounts related to failures of hardware of the robot 100, and include, for example, following body feature amounts.
(p1) Likelihood of failure probability of driving unit

This body feature amount is, for example, a body feature amount indicating that, for example, a target torque given as a command value cannot be achieved.
(p2) Likelihood of failure probability of sensor unit

This body feature amount is, for example, a feature amount indicating that sensor detection values cannot be acquired.

“(q) body feature amounts related to deformation of body” is a body feature amount related to deformation of component parts of the robot 100, and include, for example, following body feature amounts.
(q1) Attachment equipment situation

This body feature amount is, for example, a feature amount indicating that, for example, the legs or the arms are replaced, or the legs are replaced with wheels.
(q2) Change of attachments

This body feature amount is, for example, a feature amount indicating whether or not equipped attachments have changed or whether or not the attachments have deteriorated over time.
(q3) Integration with another machine

“(r) body feature amounts related to accessory equipment situation” are body feature amounts related to equipment situations of accessories such as clothes or shoes that the robot 100 can equip with, and include, for example, following body feature amounts.
(r1) Likelihood of whether or not sole pads (cushion pads to be applied to paws to reduce footsteps) are worn
(r2) Likelihood of whether or not clothes, shoes, and so on are worn

“(s) body feature amounts such as occurrence of catch by external object and so on” are body feature amounts related to situations that the robot 100 is caught by another object and cannot move, and include, for example, following body feature amounts.
(s1) Occurrence of catch by cord

As described above with reference to FIGS. 11 to 13, the environment feature amounts and the body feature amounts acquired by the environment/body feature amount extraction unit 121 by receiving an input of the detection values of the sensors of the sensing unit 110 include various feature amounts related to the environment around the robot and the body of the robot itself.

The environment feature amounts and the body feature amounts acquired by the environment/body feature amount extraction unit 121 by receiving an input of the detection values of the sensors of the sensing unit 110 are input to the behavior determination unit 123.

### (2-2. Details and Specific Examples of Processing Executed by Behavior Control Unit)

Next, the details and the specific examples of processing executed by the behavior control unit 122 of the data processing unit 120 of the robot (information processing device) 100 illustrated in FIG. 4 will be described.

As described earlier with reference to FIG. 4, the behavior control unit 122 of the data processing unit 120 of the robot (information processing device) 100 illustrated in FIG. 4 controls a behavior to be executed by the robot 100.

Note that, as described above, the behavior to be executed by the robot 100 also includes “feeling expression (presentation)” to be executed by the robot 100 in addition to an “action” such as movement of the robot 100, and the behavior control unit 122 controls the action and the feeling expression of the robot.

As described earlier with reference to FIG. 4, the behavior control unit 122 includes the behavior determination unit 123, the behavior switching control unit 124, and the behavior execution unit 125.

The behavior determination unit 123 determines the behavior to be executed by the robot 100 according to the feature amounts of the environment around the robot or the body feature amounts of the robot itself extracted by the environment/body feature amount extraction unit 121.

The behavior switching control unit 124 determines whether or not the behavior determined by the behavior determination unit 123 and a currently executed behavior are different, and outputs behavior mode information that needs to be switched and a behavior switching request to the behavior execution unit 125 when the behaviors are different.

Furthermore, the behavior execution unit 125 controls execution of various behaviors of the robot 100. More specifically, the behavior execution unit 125 controls the driving unit 126 and the display control unit 127 to control the action or the facial expression of the robot 10.

As described above, the behavior control unit 122 of the data processing unit 120 of the robot (information processing device) 100 illustrated in FIG. 4 determines the behavior to be executed by the robot 100 according to the feature amounts of the environment around the robot or the body feature amounts of the robot itself extracted by the environment/body feature amount extraction unit 121, switches the behavior when the determined behavior is different from the currently executed behavior, and controls a behavior to be executed by the robot 100.

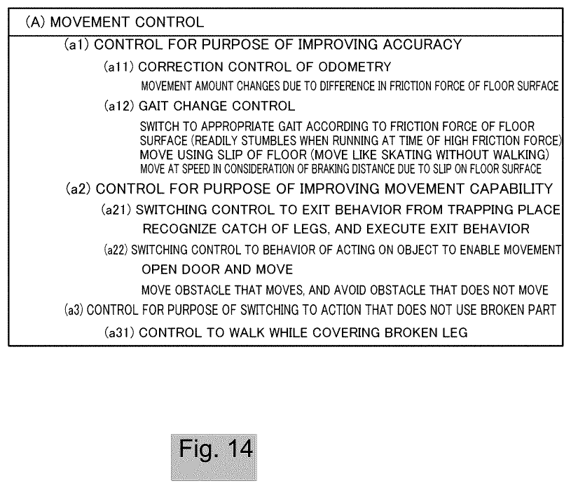

Next, an example of behavior control of the robot 100 executed by the behavior control unit 122 of the data processing unit 120 of the robot (information processing device) 100 illustrated in FIG. 4 will be described with reference to FIGS. 14 to 16.

Examples of the behavior control of the robot 100 executed by the behavior control unit 122 include a plurality of types of following behavior control as illustrated in FIGS. 14 to 16.
(A) Movement control
(B) Grip control
(C) Environment adaptation behavior control
(D) Feeling expression and conduct control

Specific examples of these behavior control will be described below with reference to FIGS. 14 to 16.

### (A) Movement Control

First, the specific examples of “(A) movement control” will be described with reference to FIG. 14.

“(A) movement control” of the robot 100 executed by the behavior control unit 122 is movement processing of the robot 100, that is, control processing related to movement such as walking or hurried running. Specific examples of this “(A) movement control” include, for example, following control.
(a1) Control for purpose of improving accuracy
(a2) Control for purpose of improving movement capability
(a3) Control for purpose of switching to action that does not use broken part

Specific examples of control to be executed as “(a1) control for purpose of improving accuracy” include control processing such as
(a11) Correction control of odometry
(a12) Gait change control.

“(a11) correction control of odometry” is odometry correction processing matching the friction force of the floor surface on which the robot 100 runs, and is running distance measurement of the robot or own position estimation algorithm correction processing of the robot using the odometries.

When receiving an input of information related to the friction force of the floor surface on which the robot 100 runs as the environment feature amount from the environment/body feature detection unit 121, the behavior control unit 122 executes odometry correction control matching the input friction force of the floor surface.

When the friction force of the floor surface on which the robot 100 runs is different, and even when the robot 100 walks or hurriedly runs at the same number of steps, the movement amount changes. Consequently, it is possible to correct running distance measurement or the own position estimation algorithm of the robot using the odometries according to the friction force of the floor surface, and estimate a correct movement amount or own position.

“(a12) gait change control” is processing of changing and controlling a walking mode of the robot 100 matching the friction force of the floor surface on which the robot 100 runs.

When receiving an input of information related to the friction force of the floor surface on which the robot 100 runs as the environment feature amount from the environment/body feature detection unit 121, the behavior control unit 122 executes gait change control matching the input friction force of the floor surface.

When, for example, the friction force of the floor surface on which the robot 100 runs is low, that is, when the floor surface is slippery, if a stride is increased, it is highly probable that the robot 100 slips and falls down. Furthermore, when the robot 100 performs walking such as hurried running at a high speed, it is highly probable that the robot 100 slips and falls down.

When the friction force of the floor surface on which the robot 100 runs is low, that is, when the floor surface is slippery, the walking mode is set such that the robot 100 walks with a reduced stride and at a low walking speed to prevent occurrence of such an accident.

Alternatively, the robot 100 may be set to move using slip of the floor, that is, to, for example, move like skating without walking.

On the other hand, when, for example, the friction force of the floor surface on which the robot 100 runs is high, that is, the floor surface is hardly slippery, even if the stride is increased, it is less probable that the robot 100 slips and falls down. In such a case, control is performed such that the robot 100 walks with an increased stride.

Note that, when the friction force of the floor surface is high, that is, when the floor surface is hardly slippery, if the robot 100 performs walking such as hurried running at a high speed, it is probable that the robot 100 stumbles, and therefore speed control matching the friction force of the floor surface is performed.

Specific examples of control to be executed as “(a2) control for purpose of improving movement capability” include control processing such as
(a21) Switching control to exit behavior from trapping place
(a22) Switching control to behavior of acting on object to enable movement.

“(a21) Switching control to exit behavior from trapping place” is control for causing the robot 100 to exit from some object that catches the leg when the leg or the like of the robot 100 is caught by the some object.

When receiving an input of information indicating that the robot 100 has been caught by the some object as the environment feature amount from the environment/body feature detection unit 121, the behavior control unit 122 executes control of starting the exit behavior based on this information.

In such a case, the behavior control unit 122 analyzes a catching mode, and executes an exit behavior matching an analysis result.

“(a22) Switching control to behavior of acting on object to enable movement” is control executed when the robot 100 continues walking by moving a certain object when, for example, the robot 100 is walking or approaches the certain object.

When receiving an input of information indicating that the robot 100 has approached some object as the environment feature amount from the environment/body feature detection unit 121, the behavior control unit 122 executes control of switching to a behavior of acting on the object to enable movement based on this information.

More specifically, when, for example, there is a door in front of the robot 100, the robot 100 is caused to open the door and continue moving.

Furthermore, when, for example, there is a movable obstacle in front of the robot 100, the robot 100 is caused to move the obstacle. Furthermore, when the obstacle is not movable, the robot 100 avoids the obstacle and moves.

Specific examples of control to be executed as “(a3) control for purpose of switching to action that does not use broken part” include, for example,
(a31) walking control while covering broken leg.

When, for example, receiving an input of the body feature amount indicating that a torque of a certain leg is abnormally high from the environment/body feature detection unit 121, the behavior control unit 122 determines that this leg has a malfunction such as some failure, and controls walking using the legs other than this leg.

### (B) Grip Control

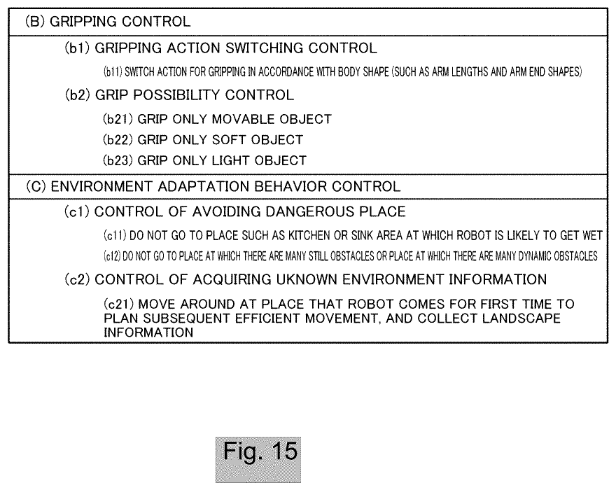

Next, specific examples of “(B) grip control” will be described with reference to FIG. 15.

“(B) grip control” of the robot 100 executed by the behavior control unit 122 is grip processing of the robot 100, that is, control processing at a time when the robot 100 grips an object using the mouth, the hands or the legs. The specific examples of this “(B) grip control” include, for example, following control.
(b1) Gripping action switching control
(b2) Grip possibility control

“(b1) gripping action switching control” is control processing related to an action mode of a gripping action of an object that the robot 100 has encountered, and specific examples of control include
(b11) Action switching control for gripping in accordance with body shape (such as arm lengths and arm tip shapes).

When receiving an input of information related to the object that the robot 100 has encountered as the environment feature amount from the environment/body feature detection unit 121, the behavior control unit 122 executes gripping action switching control matching the input information of the object.

More specifically, when, for example, the robot holds a large ball, the behavior control unit 122 causes the robot to widely spread legs and hold the ball. In a case of a small ball, the behavior control unit 122 performs control to cause the robot to hold the ball in the mouth.

“(b2) grip possibility control” is control processing related to determination classification as to whether or not the robot 100 takes an action of gripping the encountered object.

When receiving an input of information related to the object that the robot 100 has encountered as the environment feature amount from the environment/body feature detection unit 121, the behavior control unit 122 executes grip possibility control matching the input information of the object.

Specific examples of “(b2) grip possibility control” include control processing such as
(b21) Grip only movable object
(b22) Grip only soft object
(b23) Grip only light object.

### (C) Environment Adaptation Behavior Control

Next, specific examples of “(C) environment adaptation behavior control” will be described with reference to FIG. 15.

“(C) environment adaptation behavior control” of the robot 100 executed by the behavior control unit 122 is control processing for causing the robot 100 to execute a behavior that adapts to an environment in which the robot 100 exists. The specific examples of this “(C) environment adaptation behavior control” include, for example, following control.
(c1) Control of avoiding dangerous place
(c2) Control of acquiring unknown environment information

“(c1) control of avoiding dangerous place” is control processing for causing the robot 100 to execute a behavior of avoiding a dangerous place, and specific examples of control include, for example, control processing such as
(c11) Do not go to place such as kitchen or sink area at which robot is likely to get wet
(c12) Do not go to place at which there are many static obstacles or there are many dynamic obstacles.

When receiving an input of information indicating that the robot 100 is about approach a dangerous place as the environment feature amount from the environment/body feature detection unit 121, the behavior control unit 122 executes control of avoiding the dangerous place to cause the robot 100 to execute a behavior of avoiding the dangerous place.

More specifically, as described above, the behavior control unit 122 executes control that does not allow the robot to go to a place such as the kitchen or the sink area at which the robot is likely to get wet, a place at which there are many static obstacles, or a place at which there are many dynamic obstacles.

“(c2) control of acquiring unknown environment information” is control processing for causing the robot 100 to execute an information collection behavior related to an unknown place when the robot 100 encounters the unknown unexperienced environment, that is, when, for example, the robot 100 enters an unknown room.

When receiving an input of information indicating that the robot 100 is in an unknown environment that the robot 100 has never seen before as the environment feature amount from the environment/body feature detection unit 121, the behavior control unit 122 executes control of acquiring unknown environment information according to input information.

Specific examples of “(c2) control of acquiring unknown environment information” include, for example, causing the robot to execute control of
(c21) moving around at place that robot comes for first time to plan subsequent efficient movement, and collect landscape information.

### (D) Feeling Expression and Conduct Control

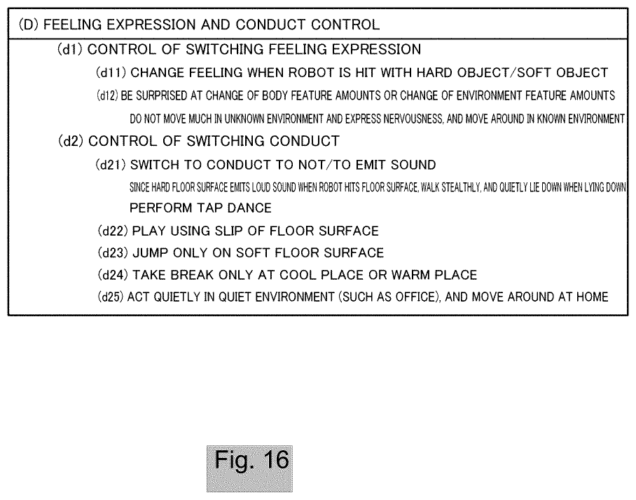

Next, specific examples of “(D) feeling expression and conduct control” will be described with reference to FIG. 16.

“(D) feeling expression and conduct control” of the robot 100 executed by the behavior control unit 122 is processing of controlling feeling expression and a conduct of the robot 100. The specific examples of this “(D) feeling expression and conduct control” include, for example, following control.
(d1) Control of switching feeling expression
(d2) Control of switching conduct

“(d1) control of switching feeling expression” is control processing for causing the robot 100 to execute feeling expression, and specific examples of control include, for example, control processing such as
(d11) Change feeling when robot is hit with hard object or soft object
(d12) Be surprised at change of body feature amounts or change of environment feature amounts.

When receiving an input of information related to occurrence of some action against the robot 100 as the environment feature amount from the environment/body feature detection unit 121, or an input of information related to a change of the body feature amounts or the environment feature amounts, or the behavior control unit 122 executes control of causing the robot 100 to execute feeling expression matching these pieces of information.

More specifically, as described above,
the behavior control unit 122 causes the robot 100 to execute feeling expression such as sadness, happiness, or anger as (d11) change feeling at time when robot is hit with hard object or soft object.

Furthermore, as (d12) be surprised at change of body feature amounts or change of environment feature amounts, the behavior control unit 122 causes the robot 100 to execute feeling expression of showing a sad and perplexed face when a failure occurs in the robot 100, and execute feeling expression of showing a hot facial expression when the temperature of the surrounding environment becomes high and becomes a hot environment.

“(d2) Control of switching conduct” is control processing for causing the robot 100 to execute various conducts, and specific examples of control include control processing such as
(d21) Switch to conduct to not emit/to emit sound
(d22) Play using slip of floor surface
(d23) Jump only on soft floor surface
(d24) Take break only at cool place or warm place
(d25) Act quietly in quiet environment (such as office) and move around at home.

When receiving an input of the environment feature amounts that are information related to various environments or body feature amounts related to the body of the robot itself from the environment/body feature detection unit 121, the behavior control unit 122 controls a conduct of the robot 100 according to these feature amounts.

When, for example, receiving an input of information indicating that the robot 100 stands on a floor that readily emits a loud sound as the environment feature amount, the behavior control unit 122 executes control of switching to a conduct that does not emit a sound as indicated in above (d21).

Furthermore, when receiving an input of information indicating that the robot 100 stands on a slippery floor as the environment feature amount, the behavior control unit 122 executes control of switching to a conduct of playing using slip on the floor surface as indicated in above (d22).

Furthermore, when receiving an input of information indicating that the robot 100 stands on a soft floor as the environment feature amount, the behavior control unit 122 executes control of switching to a conduct of jumping only on the soft floor surface as indicated in above (d23).

Furthermore, when receiving an input of information indicating that the robot 100 is at a cool place, a warm place, or the like as the environment feature amount, the behavior control unit 122 executes control of switching to a conduct of taking a break as indicated in above (d24).

Furthermore, when receiving an input of information indicating that the robot 100 is in a still environment (such as an office) as the environment feature amount, the behavior control unit 122 executes control of switching to the above conduct of (d25) act quietly.

The example of behavior control of the robot 100 executed by the behavior control unit 122 of the data processing unit 120 of the robot (information processing device) 100 illustrated in FIG. 4 has been described above with reference to FIGS. 14 to 16.

As is understood from the above description, the behavior control unit 122 determines the behavior to be executed by the robot 100 according to the feature amounts of the environment around the robot or the body feature amounts of the robot itself extracted by the environment/body feature amount extraction unit 121, and performs control of causing the robot to execute the determined behavior.

### 3. SEQUENCE OF PROCESSING EXECUTED BY ROBOT (INFORMATION PROCESSING DEVICE) ACCORDING TO PRESENT DISCLOSURE

Next, the sequence of processing executed by the robot (information processing device) according to the present disclosure

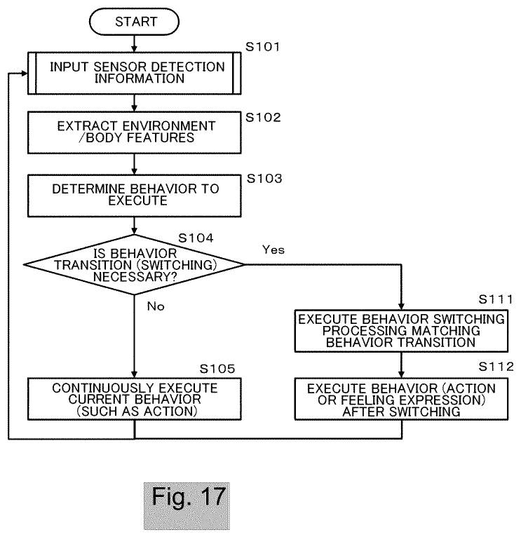

FIG. 17 is a diagram illustrating a flowchart for explaining the sequence of the processing executed by the robot (information processing device) 100 according to the present disclosure.

Note that the processing according to flowcharts in FIG. 17 and subsequent drawings is executed by the robot (information processing device) 100 employing the above-described configuration illustrated in FIG. 4.

Although not illustrated in FIG. 4, the processing can be executed according to, for example, a program stored in the storage unit of the robot 100, and is executed under control of the data processing unit (control unit) including a CPU or the like having a program execution function.

Hereinafter, processing in each step of the flowchart illustrated in FIG. 17 will be sequentially described.

### (Step S101)

First, the data processing unit 120 of the robot 100 receives an input of sensor detection information in step S101.

This processing is processing where the environment/body feature amount extraction unit 121 of the data processing unit 120 of the robot (information processing device) 100 illustrated in FIG. 4 inputs sensor detection values from the various sensors constituting the sensing unit 110.

As described earlier with reference to FIGS. 2 to 4, for example, various sensors such as the image sensor, the voice sensors, the acceleration sensor (IMU), the illuminance sensor, the wind direction/wind pressure sensor, the odor sensor, the temperature sensor, the distance sensor, the joint angle sensors, the joint torque sensors, the sole sensors, and the odometries are attached to the robot 100.

The environment/body feature amount extraction unit 121 of the data processing unit 120 of the robot (information processing device) 100 illustrated in FIG. 4 receives an input of the sensor detection values from these sensors.

Note that processing of receiving an input of these sensor detection values includes two types of processing of passive input processing of passively receiving an input of sensor detection values detected by the sensors of the sensing unit 110, and active input processing.

The active input processing is processing where the robot 100 executes a specific behavior to obtain specific sensor detection values, and receive an input of the sensor detection values that become necessary as a result of this behavior.

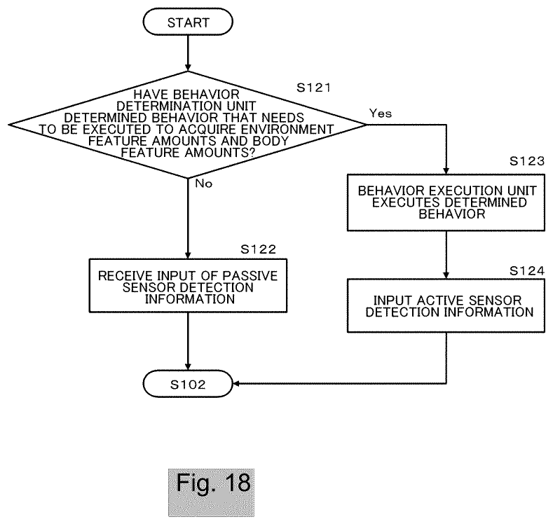

Detailed processing of sensor detection value input processing in step S101 will be described with reference to FIG. 18.

A flow illustrated in FIG. 18 is a flowchart for explaining the detailed processing of the sensor detection value input processing in step S101 of the flow illustrated in FIG. 17. Hereinafter, processing in each step of the flow illustrated in FIG. 18 will be described.

### (Step S121)

First, the data processing unit 120 of the robot 100 determines whether or not the behavior determination unit 123 has determined the behavior that needs to be executed to acquire the environment feature amounts and the body feature amounts in step S121.

More specifically, this determination corresponds to processing of determining whether or not the behavior determination unit 123 has determined to execute the behavior described with reference to FIGS. 9 and 10.

That is, the data processing unit 120 determines whether or not the behavior determination unit 123 has determined to perform a jumping behavior for performing processing of acquiring active sensor detection values for detecting hardness and slipperiness of a floor on which the robot stands when the robot 100 is about to run.

Note that, in what case the behavior determination unit 123 determines a behavior that needs to be executed to acquire the environment feature amounts and the body feature amounts is set in advance. Only when, for example, the robot 100 starts walking, the behavior determination unit 123 performs processing of determining the behavior that needs to be executed to acquire the environment feature amounts and the body feature amounts. Alternatively, when the robot 100 performs all other new behaviors including walking, the behavior determination unit 123 can make settings to perform processing of determining an advance behavior that needs to be executed to acquire the environment feature amounts and the body feature amounts before all the other new behaviors are started.

When it is determined in step S121 that the behavior determination unit 123 has determined the behavior that needs to be executed to acquire the environment feature amounts and the body feature amounts, the flow moves to step S123.

On the other hand, when it is determined that the behavior determination unit 123 has not determined the behavior that needs to be executed to acquire the environment feature amounts and the body feature amounts, the flow moves to step S122.

### (Step S122)

The processing in step S122 is executed when it is determined in step S121 that the behavior determination unit 123 has not determined the behavior that needs to be executed to acquire the environment feature amounts and the body feature amounts.

In this case, the environment/body feature amount extraction unit 121 executes the processing in step S122. That is, the environment/body feature amount extraction unit 121 receives an input of passive sensor detection information in step S122. The environment/body feature amount extraction unit 121 executes processing of passively receiving an input of the sensor detection values from the various sensors constituting the sensing unit 110.

### (Step S123)

On the other hand, when it is determined in step S121 that the behavior determination unit 123 has determined the behavior that needs to be executed to acquire the environment feature amounts and the body feature amounts, the processing in step S123 is executed.

In this case, in step S123, the behavior execution unit 125 causes the robot 100 to execute the behavior determined by the behavior determination unit 123.

For example, as described earlier with reference to FIGS. 9 and 10, the behavior execution unit 125 causes the robot 100 to execute jumping processing to perform processing of acquiring active sensor detection values for detecting hardness and slipperiness of the floor on which the robot 100 stands.

### (Step S124)

In step S123, after executing a predetermined behavior, the environment/body feature amount extraction unit 121 executes the processing in step S124.

The environment/body feature amount extraction unit 121 receives an input of active sensor detection information in step S124.

That is, in step S124, the environment/body feature amount extraction unit 121 receives an input of active sensor detection information input from the sensors of the sensing unit 110 as a result of execution of the behavior in step S123.

As described above, in step S101 of the flow illustrated in FIG. 17, at least any one of two types of processing of the passive input processing of passively receiving an input of sensor detection values detected by the sensors of the sensing unit 110, and the active input processing is executed.

After one of these processing is executed, the flow moves to step S102 of the flow illustrated in FIG. 17.

### (Step S102)

Next, the processing in step S102 of the flow illustrated in FIG. 17 will be described.

In step S102, the environment/body feature amount extraction unit 121 executes processing of extracting the environment feature amounts and the body feature amounts using the sensor detection values input in step S101.

Note that the environment feature amounts are, for example, feature amounts related to a surrounding environment of the robot 100 as described above, and are feature amounts related to various environments around the robot 100 such as information related to objects in the surroundings, material quality and hardness of a running surface (floor surface) of the robot, a time, a temperature, a user's state (such as smiling or angry), and a noisy state.

Furthermore, the body feature amounts are body feature amounts of the robot itself, and are feature amounts of whether or not accessories such as clothes, shoes, and sole pads that the robot can equip with are attached, the driving unit of the robot, and a situation of loads (torques) of, for example, the joint parts of the legs, the battery status, and the like.

Note that above-described FIG. 5 illustrates specific examples of the environment feature amounts and the body feature amounts acquired from the passive sensor detection values.

Furthermore, FIGS. 7 and 8 illustrate specific examples of the environment feature amounts and the body feature amounts acquired from the active sensor detection values.

Furthermore, FIGS. 11 and 12 illustrate specific examples of the environment feature amounts, and FIG. 13 illustrates a specific example of the body feature amounts.

In step S102, the environment/body feature amount extraction unit 121 executes processing of extracting the environment feature amounts and the body feature amounts illustrated in, for example, FIGS. 5, 7, and 8 and, moreover, FIGS. 11 to 13 using the sensor detection values input in step S101.

The environment feature amounts and the body feature amounts acquired by the environment/body feature amount extraction unit 121 are input to the behavior determination unit 123.

### (Step S103)

Next, in step S103, the robot 100 determines a behavior to execute.

This processing is processing executed by the behavior determination unit 123 of the behavior control unit 122 of the data processing unit 120 illustrated in FIG. 4.

The behavior determination unit 123 determines the behavior to be executed by the robot 100 according to the feature amounts of the environment around the robot or the body feature amounts of the robot itself extracted by the environment/body feature amount extraction unit 121.

Specific examples of the behavior to be determined are one of behaviors accompanied by control described earlier with reference to, for example, FIGS. 14 to 16, that is, these control of
(A) Movement control
(B) Grip control
(C) Environment adaptation behavior control
(D) Feeling expression and conduct control.

### (Step S104)

Next, in step S104, the robot 100 determines whether or not behavior transition (switching of the behavior) is necessary.

This processing is processing executed by the behavior switching control unit 124 of the behavior control unit 122 of the data processing unit 120 illustrated in FIG. 4.

The behavior switching control unit 124 determines whether or not the behavior determined by the behavior determination unit 123 and the currently executed behavior are different, and outputs behavior mode information that needs to be switched and a behavior switching request to the behavior execution unit 125 when the behaviors are different.

In step S104, when the behavior switching control unit 124 determines whether or not the behavior determined by the behavior determination unit 123 and the currently executed behavior are different, that is, determines that behavior transition (switching of the behavior) is necessary, the flow moves to step S111. On the other hand, when the behavior switching control unit 124 determines that the behavior determined by the behavior determination unit 123 and the currently executed behavior are the same, that is, determines that behavior transition (switching of the behavior) is not necessary, the flow moves to step S105.

### (Step S105)

Processing in step S105 is processing executed when the behavior switching control unit 124 determines that the behavior determined by the behavior determination unit 123 and the currently executed behavior are the same, that is, determines that behavior transition (switching of the behavior) is not necessary in step S104.

In this case, in step S105, the current behavior is continuously executed.

This processing is processing executed by the behavior execution unit 125 of the behavior control unit 122 of the data processing unit 120 illustrated in FIG. 4.

The behavior execution unit 125 controls execution of various behaviors of the robot 100. More specifically, the behavior execution unit 125 controls the driving unit 126 and the display control unit 127 to control the action or the facial expression of the robot 10.

The behavior executed by the behavior execution unit 125 is a behavior accompanied by control described earlier with reference to, for example, FIGS. 14 to 16, that is, these control of
(A) Movement control
(B) Grip control
(C) Environment adaptation behavior control
(D) Feeling expression and conduct control.

### (Step S111)

Processing in step S111 is processing executed when the behavior switching control unit 124 determines that the behavior determined by the behavior determination unit 123 and the currently executed behavior are different, that is, determines that behavior transition (switching of the behavior) is necessary in step S104.

In this case, in step S111, the robot 100 executes behavior switching processing matching behavior transition.

That is, the behavior switching control unit 124 outputs the behavior mode information that needs to be switched, and the behavior switching request to the behavior execution unit 125.

### (Step S112)

In this case, in step S112, the robot 100 executes the behavior after the switching processing.

That is, the behavior execution unit 125 executes the behavior after switching designated by the behavior switching control unit 124. More specifically, the behavior execution unit 125 controls the driving unit 126 and the display control unit 127 to control the action or the facial expression of the robot 10.

The behavior executed by the behavior execution unit 125 is a behavior accompanied by control described above with reference to, for example, FIGS. 14 to 16, that is, these control of
(A) Movement control
(B) Grip control
(C) Environment adaptation behavior control
(D) Feeling expression and conduct control.

Execution control of the behavior in step S105 or step S112 returns to step S101 to execute input processing of sensor consecutive appearance information, and repeatedly execute processing in step S101 and subsequent steps.

These processing enables the robot 100 to execute an optimal behavior determined according to the various environment feature amounts and body feature amounts obtained from the sensor detection values.

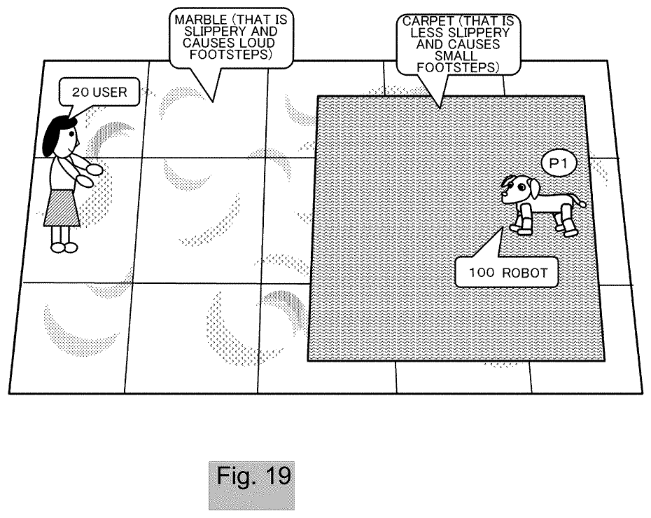

Next, one specific example of processing executed according to the flowchart in this FIG. 17 will be described to FIG. 19 and subsequent drawings.

FIG. 19 illustrates the robot 100 and a user 20 of the robot 100.

The robot 100 is at a position (P1) distant from the user 20. The user 20 beckons the robot 100 while calling the robot 100 to call the robot 100 close to the user. Note that the robot 100 is on a carpet, and the user 20 is on a marble floor. The carpet has features that the carpet is hardly slippery, and causes small footsteps. On the other hand, the marble has features that the marble is slippery and causes loud footsteps.

The robot 100 recognizes the call of the user 20 based on detection information of the sensors constituting the sensing unit 110 of the robot configuration illustrated in FIG. 4.

That is, the behavior determination unit 123 in the behavior control unit 122 of the data processing unit 120 of the robot 100 detects a beckoning action of the user 20 from a captured image of the image sensor (camera), and detects a user's call from the acquired voice of the voice sensors (microphones).

The behavior determination unit 123 determines to execute the behavior of running close to the user 20 as the behavior that responds to the detected call from the user. This behavior determination processing is executed by applying, for example, the machine learning algorithm.

Next, the behavior determination unit 123 of the robot 100 performs processing of a mode of the behavior of running close to the user 20. The behavior determination unit 123 determines, for example, a behavior mode (walking mode) such as whether the robot 100 hurriedly runs at a high speed or walks at a low speed or whether to increase the stride or reduce the stride.

The behavior determination unit 123 uses the environment feature amounts and body feature amounts extracted by the environment/body feature extraction unit 121 based on the sensor detection information for the processing of determining this behavior mode (walking mode).

The behavior determination unit 123 determines whether or not there is an active behavior for acquiring the sensor detection values that are necessary to input from the environment/body feature extraction unit 121 the environment feature amounts and the body feature amounts available for the processing of determining this behavior mode (walking mode), and, when there is such a behavior, determines this behavior as a behavior that needs to be executed.

Here, the behavior determination unit 123 determines a behavior for actively acquiring sensor detection values for acquiring environment feature amounts such as information of a floor such as material quality, whether or not the floor is slippery, and whether or not the floor causes the loud footsteps or small footsteps that are environment information that is necessary to determine the walking mode of the robot 100 for going closer to the user 20.

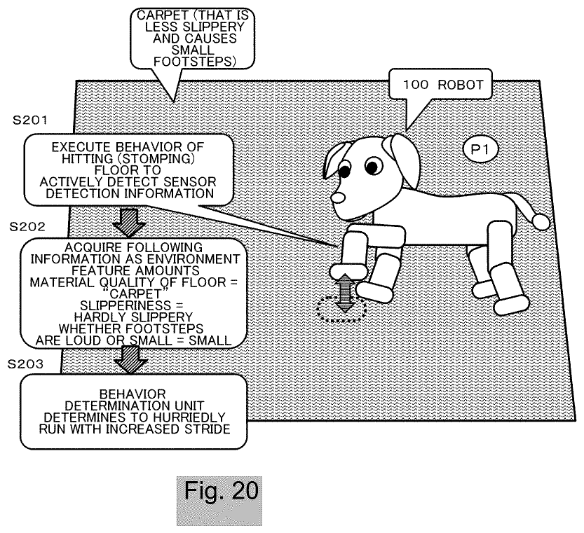

As illustrated in, for example, FIG. 20, the behavior determination unit 123 determines an action of hitting the floor by the legs of the robot 100, that is, an action of stomping the floor and acquiring detection values of the sole sensors, a detection sound of the voice sensors, or the like as an action that needs to be executed, and causes the behavior execution unit 125 to execute the action. Furthermore, the behavior determination unit 123 may direct the image sensor (camera) to the direction of the floor, and cause the behavior execution unit 125 to execute a behavior of acquiring images of the floor.

Step S201 illustrated in FIG. 20 is described as processing of executing a behavior for this active sensor detection value acquisition processing.

Processing in this step S201 corresponds to processing in step S123 of the flow described earlier with reference to FIG. 18.

The active sensor detection values obtained by the processing in step S201 illustrated in FIG. 20, that is, stomping processing that is a behavior for the active sensor detection value acquisition processing are input to the environment/body feature extraction unit 121.

This processing corresponds to the processing in step S124 of the flow described earlier with reference to FIG. 18.

For example, the detection values of the sole sensors, the detection sound of the voice sensors, and, moreover, and the sensor detection value of the image of the floor or the like obtained by the image sensor (camera) are input to the environment/body feature extraction unit 121.

The environment/body feature extraction unit 121 analyzes these input sensor detection values, and extracts the environment feature amounts and the body feature amounts.

More specifically, the environment/body feature extraction unit 121 extracts the environment feature amounts such as the material quality of the floor, slipperiness of the floor, and whether the floor causes the loud or small footsteps at the time of walking, and the body feature amounts such as whether or not accessories such as the shoes or the sole pads are equipped.

The example illustrated in FIG. 20 indicates an example where following information is acquired as the environment feature amounts as indicated by step S202 in FIG. 20.
Material quality of floor=“carpet”
Slipperiness=hardly slippery
Whether footsteps are loud or small=small

Processing indicated by step S202 in this FIG. 20 corresponds to the processing in step S102 of the flow in FIG. 17.

The environment/body feature extraction unit 121 inputs these extracted environment feature amounts to the behavior determination unit 123.

The behavior determination unit 123 determines an optimal behavior, that is, the walking mode based on these feature amounts.

More specifically, the behavior determination unit 123 determines to hurriedly run with an increased stride as indicated by, for example, step S203 in FIG. 20.

This is the optimal behavior mode (walking mode) according to the environment feature amounts indicating that the material quality of the floor is the “carpet”, the floor is hardly slippery, and the floor also causes small footsteps, and the behavior determination unit 123 determines to hurriedly run with the increased stride as an optimal walking mode based on these environment feature amounts.

Processing indicated by step S203 in this FIG. 20 corresponds to the processing in step S103 of the flow in FIG. 17.

Subsequently, the robot 100 executes the behavior according to the determined behavior mode. That is, the behavior execution unit 125 causes the robot 100 to start hurriedly run with the increased stride.

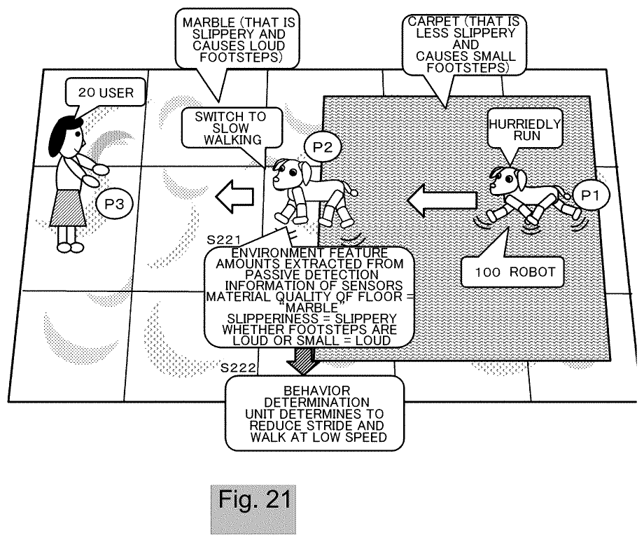

FIG. 21 is a diagram for explaining a state after the robot 100 starts hurriedly running.

The robot 100 starts hurriedly running with the increased stride from the position (P1).

However, at a point of time when the robot 100 reaches a position (P2), the floor surface subsequently changes from the “carpet” to the “marble”.

The sensors of the robot 100 continuously execute sensing processing while the robot 100 is running, too.

For example, the sole sensors continuously detect the hardness and the friction force of the floor surface, and input detection values to the environment/body feature extraction unit 121.

The environment/body feature extraction unit 121 recognizes a change of the sensor detection values input from the sole sensors at the point of time when the robot 100 reaches the position (P2). That is, the environment/body feature extraction unit 121 recognizes that the hardness and the friction force of the floor surface have changed, and executes processing of updating the environment feature amounts according to the new detection values.

As indicated by step S221 in FIG. 21, following environment feature amounts are extracted based on the passive detection information of the sensors.
Material quality of floor=“marble”
Slipperiness=slippery
Whether footsteps are loud or small=loud

As described above, the environment/body feature extraction unit 121 detects that the floor has changed to the marble at the point of time when the position of the robot 100 reaches (P2).

Processing indicated by step S221 in this FIG. 21, that is, input of the passive sensor detection values and feature amount extraction processing correspond to the processing in step S122 of the flow in FIG. 18 and the processing in step S102 of the flow in FIG. 17.

The environment/body feature extraction unit 121 inputs these extracted environment feature amounts to the behavior determination unit 123.

The behavior determination unit 123 determines an optimal behavior, that is, a new walking mode based on these feature amounts.

More specifically, the behavior determination unit 123 determines to walk at a low speed with the reduced stride as indicated by, for example, step S222 in FIG. 21.

This walking is an optimal behavior mode (walking mode) according to the environment feature amounts indicating that the material quality of the floor is the “marble”, the floor is slippery, and the floor causes loud footsteps, and the behavior determination unit 123 determines to walk at the low speed with the reduced stride as the optimal walking mode based on these environment feature amounts.

Processing indicated by step S222 in this FIG. 21 corresponds to the processing in step S103 of the flow in FIG. 17.

Subsequently, the robot 100 executes the behavior according to the determined behavior mode. That is, the behavior execution unit 125 causes the robot 100 to walk at the low speed with the reduced stride, and run a row close to the user 20.

As described above, the robot 100 according to the present disclosure employs a configuration that determines and executes an optimal behavior according to the various environment feature amounts and body feature amounts obtained from the sensor detection values.

Note that the examples described with reference to FIGS. 19 to 21 are specific examples in a case where the robot 100 is not equipped with the accessories such as the shoes or the sole pads.

In this case, the environment/body feature extraction unit 121 detects that the accessories are not equipped as the body feature amounts of the robot 100, and the behavior determination unit 123 determines an optimal behavior based on this detection information.

By contrast with this, when the robot 100 is equipped with the accessories such as the shoes or the sole pads, the environment/body feature extraction unit 121 detects that, for example, the “shoes” are equipped as the body feature amount of the robot 100, and the behavior determination unit 123 determines an optimal behavior based on this detection information.

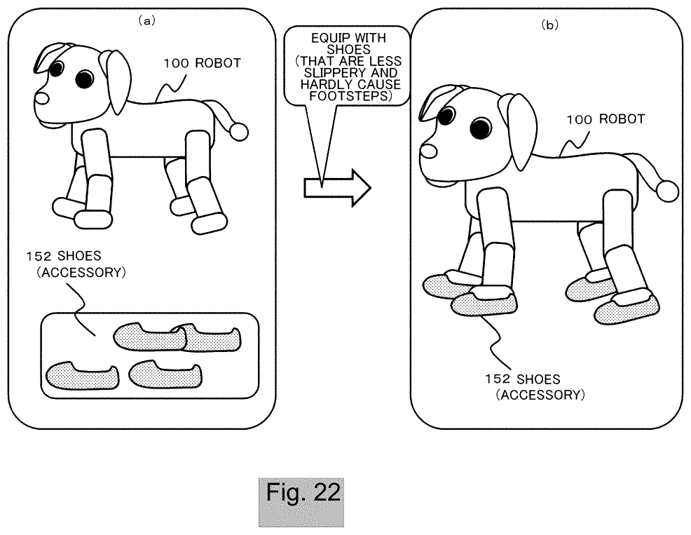

Specific examples will be described with reference to FIG. 22 and subsequent drawings.

It is assumed that, as illustrated in FIG. 22, the robot 100 is equipped with the “shoes” 152 that are accessories that the robot 100 can equip with.

By equipping with the “shoes”, the robot 100 hardly slips or causes small footsteps.

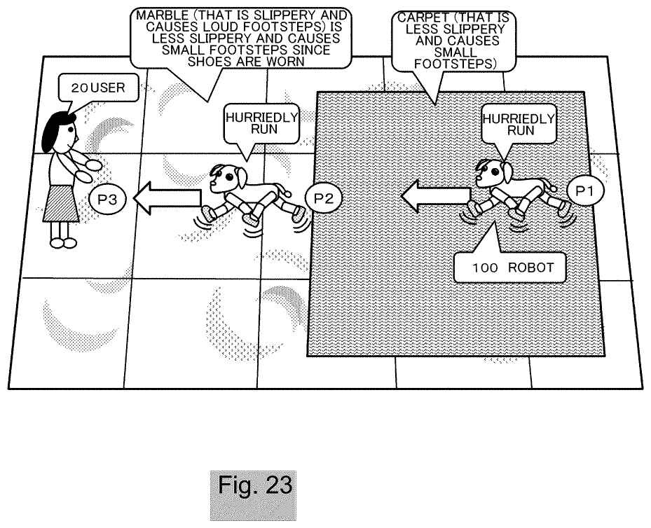

FIG. 23 illustrates a processing example in a case where the robot 100 is equipped with the “shoes” 152 that are the accessories.

The environment/body feature extraction unit 121 of the robot 100 extracts the environment feature amounts and the body feature amounts using the active sensor detection values when the robot 100 is at the position (P1).

That is, the environment/body feature extraction unit 121 executes, for example, an action of hitting the floor by the leg, and extracts following environment feature amounts and body feature amounts.

### (a) Environment Feature Amount

Material quality of floor=“carpet”
Slipperiness=hardly slippery
Whether footsteps are loud or small=small

### (b) Body Feature Amount

Equipped accessory=shoes
Slipperiness=hardly slippery
Whether footsteps are loud or small=small

The environment/body feature extraction unit 121 inputs these extracted environment feature amounts to the behavior determination unit 123.

The behavior determination unit 123 determines an optimal behavior, that is, the walking mode based on these feature amounts.

More specifically, the behavior determination unit 123 determines to hurriedly run with an increased stride as indicated by, for example, the robot 100 at the position (P1) in FIG. 23.

This running is the optimal behavior mode (walking mode) according to the environment feature amounts indicating that the material quality of the floor is the “carpet”, the floor is hardly slippery, and the floor also causes small footsteps, and the body feature amounts indicating that the floor is hardly slippery and the floor also causes small footsteps, and the behavior determination unit 123 determines to hurriedly run with the increased stride as an optimal walking mode based on these environment feature amounts.

The robot 100 starts hurriedly running with the increased stride from the position (P1) according to the determined behavior.

However, at a point of time when the robot 100 reaches the position (P2), the floor surface subsequently changes from the “carpet” to the “marble”.

The sensors of the robot 100 continuously execute sensing processing even while the robot 100 is running.

For example, the sole sensors continuously detect the hardness and the friction force of the floor surface, and input detection values to the environment/body feature extraction unit 121.

The environment/body feature extraction unit 121 executes processing of updating the environment feature amounts and the body feature amounts according to the new sensor detection values at the point of time when the robot 100 reaches the position (P2). The environment/body feature extraction unit 121 extracts, for example, following new environment feature amounts and body feature amounts.

### (a) Environment Feature Amount

Material quality of floor=“marble”
Slipperiness=slippery
Whether footsteps are loud or small=loud

### (b) Body Feature Amount

Equipped accessory=shoes
Slipperiness=hardly slippery
Whether footsteps are loud or small=small

As described above, the environment/body feature extraction unit 121 detects that the floor has changed to the marble at the point of time when the position of the robot 100 reaches (P2).

The environment/body feature extraction unit 121 inputs these extracted environment feature amounts and body feature amounts to the behavior determination unit 123.

The behavior determination unit 123 determines an optimal behavior, that is, a new walking mode based on these feature amounts.

The behavior determination unit 123 determines the optimal behavior mode (walking mode) in consideration of two types of the feature amounts of the environment feature amounts indicating that the material quality of the floor is the “marble”, the floor is slippery, and the floor causes loud footsteps, and the body feature amounts indicating that the floor is hardly slippery and the floor also causes small footsteps since the “shoes” that are the accessories are equipped.

In this example, the behavior determination unit 123 determines to hurriedly run with the increased stride as an optimal walking mode based on these environment feature amounts.

This running is the optimal behavior mode (walking mode) according to a fact that the feature amounts include the environment feature amounts indicating that the material quality of the floor is the “marble”, the floor is slippery, and the floor causes loud footsteps, and the body feature amounts indicating that the floor is hardly slippery and the floor also causes quiet footsteps since the robot 100 is equipped with the “shoes” that are the accessories, and the behavior determination unit 123 determines a behavior of hurriedly running with the increased stride as an optimal walking mode based on these environment feature amounts.

As a result, the robot 100 continuously hurriedly runs with the increased stride from the position (P1) to (P2) and then to (P3), and reaches the position (P3) of the user 20.

As described above, the robot 100 according to the present disclosure determines and executes an optimal behavior according to the various environment feature amounts and body feature amounts obtained from the sensor detection values.

### 4. OTHER CONFIGURATION EXAMPLE OF ROBOT (INFORMATION PROCESSING DEVICE) ACCORDING TO PRESENT DISCLOSURE

Next, the other configuration example of the robot (information processing device) according to the present disclosure will be described.

The configuration example of the robot (information processing device) 100 according to the present disclosure has been described earlier with reference to FIG. 4.

The configuration of the robot (information processing device) 100 illustrated in FIG. 4 is a configuration example of the robot (information processing device) 100 that executes processing according to the present disclosure.

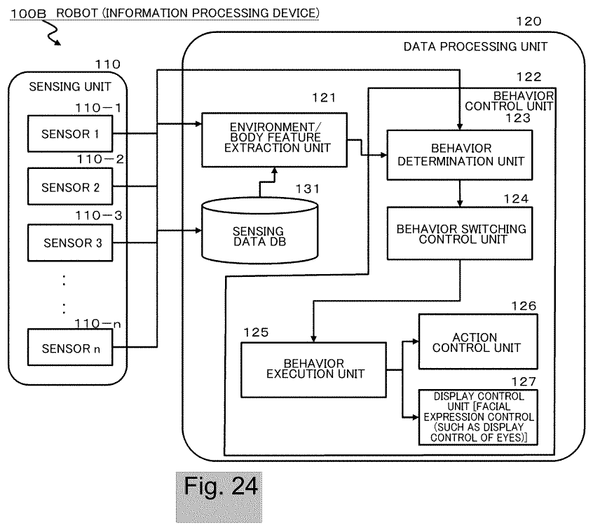

Next, a configuration example of the robot (information processing device) 100 different from the configuration illustrated in FIG. 4 will be described with reference to FIG. 24 and subsequent drawings.

Following configuration examples will be sequentially described below.
(a) Configuration example including sensing database
(b) Configuration example including environment/feature amount database
(c) Configuration example including sensing database and environment/feature amount database

### (a) Configuration Example Including Sensing Database

First, a configuration example of a robot (information processing device) 100B including the sensing database will be described.

FIG. 24 is a diagram illustrating the configuration example of the robot (information processing device) 100B including the sensing database.

The robot (information processing device) 100B illustrated in FIG. 24 includes the sensing unit 110 and the data processing unit 120.

The sensing unit 110 includes the various sensors described with reference to FIGS. 2 and 3, and collects information on a surrounding environment.

As illustrated in FIG. 24, the data processing unit 120 includes the environment/body feature extraction unit 121, the behavior control unit 122, and a sensing DataBase (DB) 131.

The behavior control unit 122 includes the behavior determination unit 123, the behavior switching control unit 124, the behavior execution unit 125, the action control unit 126, and the facial expression control unit 127.

The components other than the sensing DataBase (DB) 131 are the same components as the components described earlier with reference to FIG. 4.

The sensing DataBase (DB) 131 receives an input of various items of sensor detection data from the sensing unit 110, and associates the various sensor detection values with detection time information to record. That is, the sensing DataBase (DB) 131 stores history data of the sensor detection values.

The history data of the sensor detection values stored in this sensing DataBase (DB) 131 is referred to by the environment/body feature amount extraction unit 121 as necessary.

The environment/body feature amount extraction unit 121 receives an input of various items of sensor detection data from the sensing unit 110, and extracts feature amounts of the environment around the robot and the body feature amounts of the robot itself using a machine learning model based on the input data.

The environment/body feature amount extraction unit 121 further executes processing of cross-checking current sensor detection values input from the sensing unit 110, and the history data of the sensor detection values stored in the sensing DataBase (DB) 131.

For example, the environment/body feature amount extraction unit 121 compares a face image of a person acquired by the image sensor (camera) and a face image stored in the sensing DataBase (DB) 131 and previously detected by the sensor, and determines whether or not the person acquired by the image sensor (camera) has also been previously photographed, that is, whether or not the person is a person that the robot 100 has previously met.

The environment/body feature amount extraction unit 121 also performs processing of, for example, cross-checking current images of not only the person but also a room, a scenery, or the like, and past images stored in the sensing DataBase (DB) 131, and determining whether or not the room or the scenery is a room or a scenery that the robot 100 has previously seen.

For example, the environment/body feature amount extraction unit 121 compares a voice of a certain person acquired by the voice sensors (microphones) and an audio (voice) stored in the sensing DataBase (DB) 131 and previously detected by the sensors, and determines whether or not the voice of the person acquired by the voice sensors (microphones) has also been previously photographed, that is, whether or not the person is a person that the robot 100 has previously met.

As described above, by using the past sensor detection values stored in the sensing DataBase (DB) 131, the environment/body feature amount extraction unit 121 can execute processing of cross-checking the current sensor detection values input from the sensing unit 110, and the history data of the sensor detection values stored in the sensing DataBase (DB) 131, and determine whether or not the current sensor values match with the previously acquired sensor detection values.

As a result, the environment/body feature amount extraction unit 121 can extract, for example, an environment feature amount indicating that a person in front of the robot 100 is a person that the robot 100 sees for the first time or a person that the robot 100 has met many times.

Furthermore, for example, the environment/body feature amount extraction unit 121 can extract, for example, an environment feature amount indicating that a room in which the robot 100 exists is a room in which the robot 100 enters for the first time or a room in which the robot 100 has entered many times.

### (b) Configuration Example Including Environment/Feature Amount Database

Next, the configuration example of a robot (information processing device) 100C including the environment/feature amount database will be described.

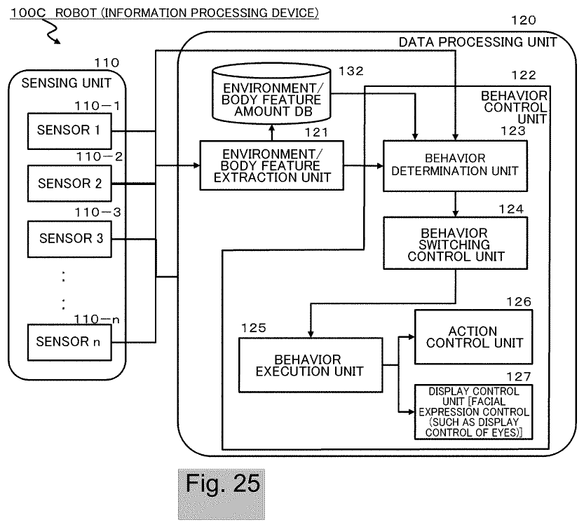

FIG. 25 is a diagram illustrating the configuration example of the robot (information processing device) 100C including the environment/feature amount database.

The robot (information processing device) 100C illustrated in FIG. 25 includes the sensing unit 110 and the data processing unit 120.

The sensing unit 110 includes the various sensors described with reference to FIGS. 2 and 3, and collects information on a surrounding environment.

As illustrated in FIG. 25, the data processing unit 120 includes the environment/body feature extraction unit 121, the behavior control unit 122, and an environment/feature amount DataBase (DB) 132.

The behavior control unit 122 includes the behavior determination unit 123, the behavior switching control unit 124, the behavior execution unit 125, the action control unit 126, and the facial expression control unit 127.

The components other than the environment/feature amount DataBase (DB) 132 are the same components as the components described earlier with reference to FIG. 4.

The environment/feature amount DataBase (DB) 132 associates the environment feature amounts and the body feature amounts extracted by the environment/body feature amount extraction unit 121 with extracted time information to record. That is, the environment/feature amount DataBase (DB) 132 stores history data of extracted feature amounts.

More specifically, the environment/feature amount DataBase (DB) 132 associates environment feature amounts such as colors of clothes of people, shapes of rooms, furniture of the rooms, and arrangement of the furniture with the time information to record.

The history data of the feature amounts stored in this environment/feature amount DataBase (DB) 132 is referred to by the behavior determination unit 123 as necessary.

The behavior determination unit 123 compares, for example, current environment feature amounts or body feature amounts input from the environment/body feature amount extraction unit 121, and past environment feature amounts or body feature amounts stored in the environment/feature amount DataBase (DB) 132, detects a change of the environment around the robot or a change of the robot itself, and determines an optimal behavior matching a difference of the change.

More specifically, when, for example, receiving an input of a feature amount indicating that the floor of the room is “a marble floor with a carpet laid thereon” as a current environment feature amount input from the environment/body feature amount extraction unit 121, and acquires a feature amount indicating that the floor of the room is “a marble floor without a carpet laid thereon” as a past environment feature amount from the environment/feature amount DataBase (DB) 132, the behavior determination unit 123 performs processing of recognizing that the user has laid down the carpet, and determining to joyfully run around as a behavior that needs to be executed.

Furthermore, when, for example, receiving an input of a feature amount indicating that “the user is a user having short hair” as a current environment feature amount input from the environment/body feature amount extraction unit 121, and acquires a feature amount indicating that “the user is a user having long hair” as a past environment feature amount from the environment/feature amount DataBase (DB) 132, the behavior determination unit 123 performs processing of recognizing that “the user has had the hair cut”, and determining to show a surprised facial expression as a behavior that needs to be executed.

### (c) Configuration Example Including Sensing Database and Environment/Feature Amount Database

Next, the configuration example of a robot (information processing device) 100D including the sensing database and the environment/feature amount database will be described.

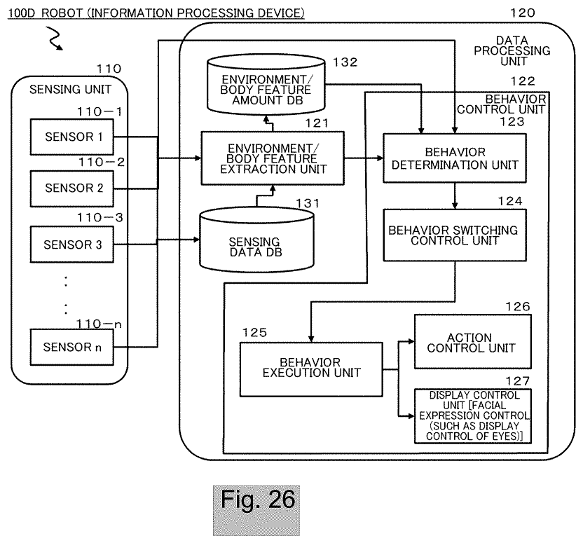

FIG. 26 is a diagram illustrating the configuration example of the robot (information processing device) 100D including the sensing database and the environment/feature amount database.

The robot (information processing device) 100D illustrated in FIG. 26 includes the sensing unit 110 and the data processing unit 120.

The sensing unit 110 includes the various sensors described with reference to FIGS. 2 and 3, and collects information on a surrounding environment.

As illustrated in FIG. 24, the data processing unit 120 includes the environment/body feature extraction unit 121, the behavior control unit 122, the sensing DataBase (DB) 131, and the environment/feature amount database (DB) 132.

The behavior control unit 122 includes the behavior determination unit 123, the behavior switching control unit 124, the behavior execution unit 125, the action control unit 126, and the facial expression control unit 127.

The components other than the sensing DataBase (DB) 131 and the environment/feature amount DataBase (DB) 132 are the same components as the components described earlier with reference to FIG. 4.

The configuration illustrated in this FIG. 26 is a configuration obtained by combining the configuration illustrated in FIG. 24 and the configuration illustrated in FIG. 25.

That is, the sensing DataBase (DB) 131 receives an input of various items of sensor detection data from the sensing unit 110, and associates the various sensor detection values with detection time information to record. That is, the sensing DataBase (DB) 131 stores history data of the sensor detection values. The history data of the sensor detection values stored in this sensing DataBase (DB) 131 is referred to by the environment/body feature amount extraction unit 121 as necessary.

Furthermore, the environment/feature amount DataBase (DB) 132 associates the environment feature amounts and the body feature amounts extracted by the environment/body feature amount extraction unit 121 with extracted time information to record. That is, the environment/feature amount DataBase (DB) 132 stores history data of extracted feature amounts.

More specifically, the environment/feature amount DataBase (DB) 132 associates environment feature amounts such as colors of clothes of people, shapes of rooms, furniture of the rooms, and arrangement of the furniture.

The history data of the feature amounts stored in this environment/feature amount DataBase (DB) 132 is referred to by the behavior determination unit 123 as necessary.

The configuration illustrated in this FIG. 26 is a configuration that can execute any processing of processing that uses data stored in the sensing DataBase (DB) 131 described earlier with reference to FIG. 24, and processing that uses data stored in the environment/feature amount DataBase (DB) 132 described with reference to FIG. 25.

### 5. SPECIFIC EXAMPLES OF PROCESSING THAT USES ROBOT (INFORMATION PROCESSING DEVICE) ACCORDING TO PRESENT DISCLOSURE

Next, specific examples of processing that uses the robot (information processing device) according to the present disclosure will be described.

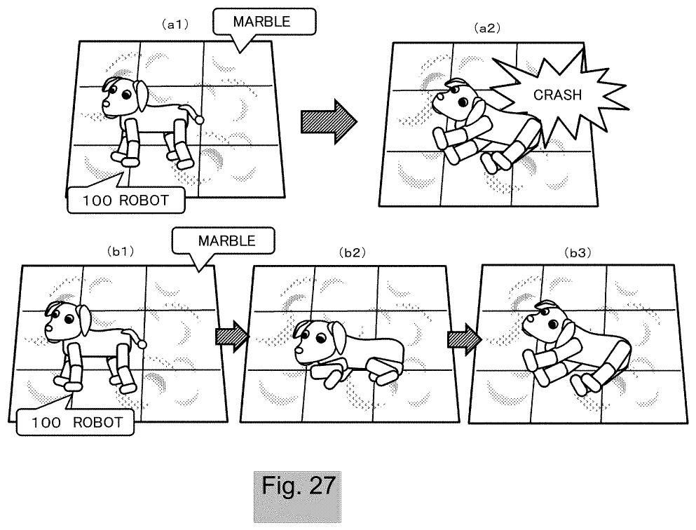

Specific examples of processing that uses the robot (information processing device) according to the present disclosure will be described with reference to FIG. 27 and subsequent drawings.

The following specific examples will be sequentially described.
(Specific example 1) Processing of switching lying action of robot according to softness of floor surface
(Specific example 2) Processing of switching walking action of robot according to features of floor surface and equipped accessories
(Specific example 3) Reaction in case where robot is put in unknown environment
(Specific example 4) Processing of switching behavior of robot according to user's action for robot

### (Specific Example 1) Processing of Switching Lying Action of Robot According to Softness of Floor Surface

First, processing of switching a lying action of the robot according to softness of a floor surface will be described as (specific example 1).

When suddenly performing a lying action on a hard floor surface such as a marble as illustrated in, for example, diagrams (a1) and (a2) on the upper part in FIG. 27, the robot 100 causes a loud sound.

However, when slowly lying down without any momentum as illustrated in diagrams (b1) to (b3) at the lower part in FIG. 27, the robot 100 causes a small sound.

Furthermore, although a sound does not matter in a case of a soft floor surface with a carpet or the like laid thereon, when lying down on the soft floor surface with the carpet or the like laid thereon without a momentum, the robot 100 cannot roll much, great loads apply to the joints of the robot 100, and a failure occurs depending on cases.

The above-described robot 100 according to the present disclosure does not cause these problems.

More specifically, for example, the robot 100 performs a behavior of hitting the floor surface to acquire active sensor detection values.

The voice sensors acquire a sound caused by this behavior of hitting the floor surface, and the IMU sensor acquires vibration.

The environment/body feature extraction unit 121 receives an input of these sensor detection values, and extracts the environment feature amounts using a discriminator that uses machine learning.

More specifically, the environment/body feature extraction unit 121 determines hardness of the floor surface.

The environment/body feature extraction unit 121 inputs to the behavior determination unit 123 information on the hardness of the floor surface that is the environment feature amount extracted by the environment/body feature extraction unit 121.

The behavior determination unit 123 determines an optimal behavior based on the information on the hardness of the floor surface that is the environment feature amount extracted by the environment/body feature extraction unit 121.

When, for example, the floor surface is a hard floor surface such as a marble, the behavior determination unit 123 executes a slow lying action as illustrated in (b1) to (b3) in FIG. 27.

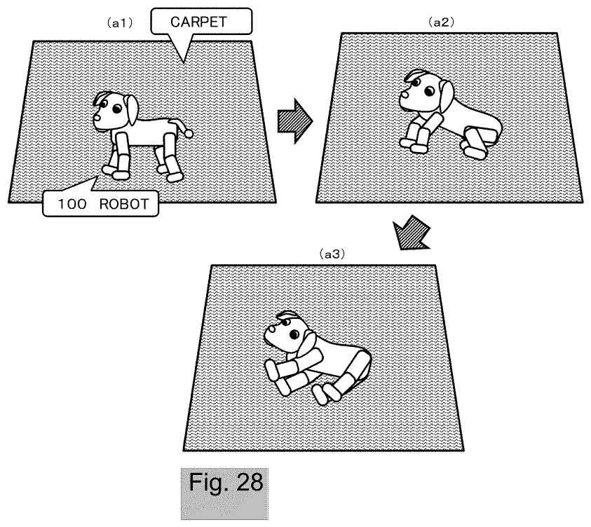

Furthermore, when the floor surface is a soft floor surface such as a carpet, the behavior determination unit 123 executes a lying action that does not cause burdens on the legs as illustrated in (a1) to (a3) in FIG. 28.

As described above, by applying the processing according to the present disclosure, it is possible to execute the lying action of the robot 100 as an optimal lying action matching hardness or softness of the floor surface.

### (Specific Example 2) Processing of Switching Walking Action of Robot According to Features of Floor Surface and Equipped Accessories

Next, processing of switching a walking action of the robot according to features of a floor surface and equipped accessories will be described as (specific example 2).

For example, although the “shoes” or the “sole pads” described earlier with reference to FIG. 6 provide a slip prevention effect, when, for example, the robot 100 runs on a “carpet” or the like whose friction is strong and that has long fibers, there is a case where the legs get caught, and the robot 100 readily stumbles.

The above-described robot 100 according to the present disclosure can solve this problem.

More specifically, for example, the robot 100 performs a behavior of hitting a floor surface to acquire active sensor detection values.

The voice sensors acquire a sound caused by this behavior of hitting the floor surface, and the IMU sensor acquires vibration.

The environment/body feature extraction unit 121 receives an input of these sensor detection values, and extracts the environment feature amounts using the discriminator that uses machine learning.

More specifically, the environment/body feature extraction unit 121 acquires information indicating that the floor surface is a “carpet” as the environment feature amount.

Furthermore, the environment/body feature extraction unit 121 detects that the legs of the robot 100 are equipped with the “shoes” or the “sole pads” as the body feature amount.

The information indicating the floor surface=the “carpet” that is the environment feature amount extracted by the environment/body feature extraction unit 121, and the body feature amount indicating that the legs of the robot 100 are equipped with the “shoes” or the “sole pads” are input to the behavior determination unit 123.

The behavior determination unit 123 determines an optimal behavior based on the environment feature amount (the floor surface=the “carpet”) and the body feature amount (the legs of the robot 100 are equipped with the “shoes” or the “sole pads”) extracted by the environment/body feature extraction unit 121.

For example, the behavior determination unit 123 determines a behavior of slowly walking on the carpet with a reduced stride as a behavior that is executed such that the legs of the robot 100 do not get caught. Alternatively, the behavior determination unit 123 makes determination such that the robot 100 does not walk on the carpet.

As described above, by applying the processing according to the present disclosure, it is possible to execute the walking action of the robot 100 as an optimal walking action matching material quality of the floor surface and accessories equipped by the robot 100.

### (Specific Example 3) Reaction in Case where Robot is Put in Unknown Environment

Next, a reaction in a case where the robot is put in an unknown environment will be described as (specific example 3).

When, for example, the robot 100 is put in a new environment, more specifically, when, for example, the robot 100 sees a scenery that the robot 100 has never seen before, the facial expression of the robot 100 is set to a happy facial expression or a surprised facial expression.

By making such a facial expression change, feeling expression of the robot 100 for an environment change can be executed as feeling expression close to a human being or an actual animal.

The above-described robot 100 according to the present disclosure can execute such feeling expression.

More specifically, the robot 100 can input to the environment/body feature extraction unit 121, for example, acquired images of the image sensor (camera) constituting the sensing unit 110 of the robot 100, acquired distance information of the distance sensor, and the like.

The environment/body feature extraction unit 121 receives an input of these sensor detection values, and extracts the environment feature amounts related to the environment around the robot 100.

The environment/body feature extraction unit 121 further executes processing (cross-check processing) of matching the extracted environment feature amounts and environment feature amounts previously stored in the environment/feature amount database 132 described earlier with reference to FIG. 25. The environment/body feature extraction unit 121 determines the degree of match with the environment feature amounts acquired from the sensor detection values.

When past environment feature amounts whose degree of match with the environment feature amounts extracted from the sensor detection values is high are not extracted from accumulated data, the environment/body feature extraction unit 121 determines that a scenery that the robot 100 is currently seeing is a new environment.

In response to a result of determination, the environment/body feature extraction unit 121 generates an environment feature amount indicating that the current environment is a new environment, and outputs the environment feature amount to the behavior determination unit 123.

The behavior determination unit 123 determines to output a happy facial expression or a surprised facial expression as a behavior that needs to be executed, based on the environment feature amount (current environment=new environment extracted by the environment/body feature extraction unit 121.

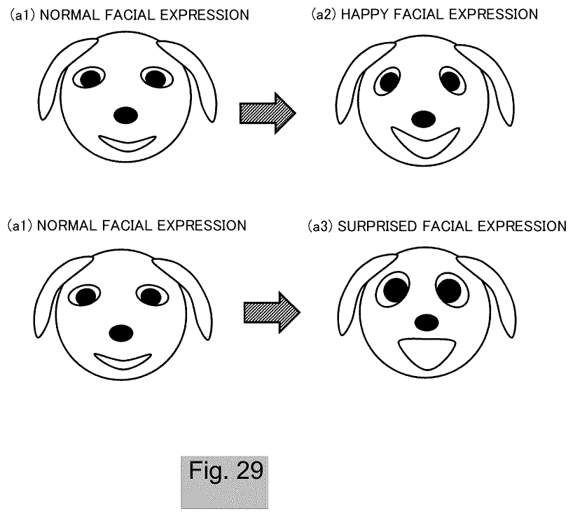

The behavior execution unit 125 changes the facial expression of the robot 100 to the happy facial expression or the surprised facial expression according to determination information of the behavior determination unit 123 as illustrated in, for example, FIG. 29.

Furthermore, the behavior determination unit 125 may determine to execute an exploration behavior that causes the robot 100 to walk around in the new environment according to, for example, a fact that the current environment is the new environment, and cause the behavior execution unit 125 to execute the exploration behavior.

As described above, by applying the processing according to the present disclosure, it is possible to change the facial expression of the robot 100 in response to the environment around the robot, and cause the robot 100 to make a reaction closer to an actual human being or animal.

### (Specific Example 4) Processing of Switching Behavior of Robot According to User's Action for Robot

Next, the processing of switching a behavior of the robot according to a user's action for the robot will be described as (specific example 4).

For example, there is a case where the robot 100 is stroked or hit by the user. Even the case where the robot 100 is hit includes a case where the robot 100 is hit to softly cradle or is hit to cause pain.

The robot 100 according to the present disclosure can make an accurate reaction in response to these various user's actions.

The robot 100 inputs sensor detection values detected by the sensors at a time of execution of a user's action such as an action of stroking, soft hitting, or hard hitting are input to the environment/body feature extraction unit 121.

Examples of the sensor detection values are detection values of the vibration sensor such as the IMU, the voice sensors, the image sensor, or the like.

The environment/body feature extraction unit 121 executes analysis processing that applies the machine learning algorithm based on these sensor detection values, and determines types of user's actions. That is, the environment/body feature extraction unit 121 extracts as an environment feature amount a result obtained by determining whether, for example, the user is performing soft stroking, soft hitting, or hard hitting.

The environment/body feature extraction unit 121 extracts, for example, one of following environment feature amounts according to the sensor detection values.
Environment feature amount=user is softly stroking
Environment feature amount=user is softly hitting
Environment feature amount=user is hitting hard

The environment/body feature extraction unit 121 extracts, for example, these different environment feature amounts according to the sensor detection values.

The environment/body feature extraction unit 121 inputs the extracted environment feature amount to the behavior determination unit 123.

The behavior determination unit 123 determines respectively different behaviors based on the environment feature amount extracted by the environment/body feature extraction unit 121, that is, one of the following environment feature amounts of
Environment feature amount=user is softly stroking
Environment feature amount=user is softly hitting
Environment feature amount=user is hitting hard.

When, for example, receiving an input of “environment feature amount=user is softly stroking” or “environment feature amount=user is softly hitting”, the behavior determination unit 123 determines a behavior of changing the facial expression of the robot 100 to a happy facial expression as a behavior that needs to be executed.

On the other hand, when receiving an input of “environment feature amount=user is hitting hard”, the behavior determination unit 123 determines a behavior of changing the facial expression of the robot 100 to a sad facial expression or an angry facial expression as a behavior that needs to be executed.

The behavior execution unit 125 changes the facial expression of the robot 100 to a happy facial expression, a sad facial expression, or a surprised facial expression according to determination information of the behavior determination unit 123.

As described above, by applying the processing according to the present disclosure, it is possible to cause the robot 100 to more naturally react to various user's reactions.

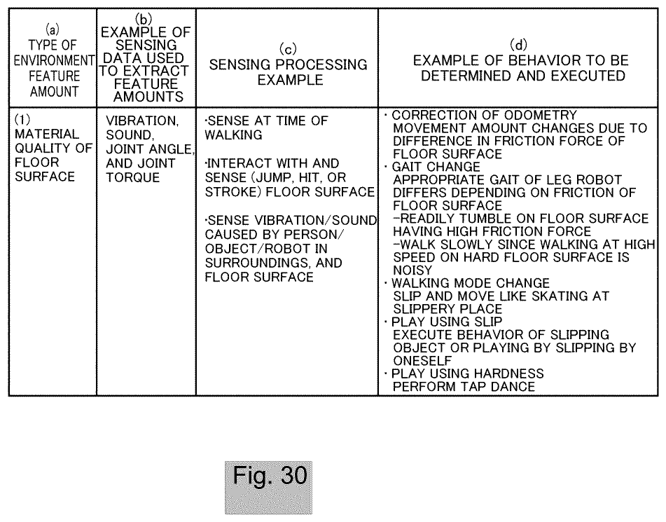

Next, specific examples of other processing that can be executed by the robot (information processing device) 100 according to the present disclosure will be described with reference to FIG. 30 and subsequent drawings.

FIGS. 30 to 32 illustrate tables for explaining the specific examples of processing matching types of the environment feature amounts extracted by the environment/body feature extraction unit 121.

More specifically, FIGS. 30 to 32 illustrate the specific examples of the processing matching the following types as the types of the extracted environment feature amounts.
(1) Type of environment feature amount=material quality of floor surface
(2) Type of environment feature amount=structure and type of room
(3) Type of environment feature amount=material of object
(4) Type of environment feature amount=state against person
(5) Type of environment feature amount=state of oneself (robot)

In the tables, each following data is associated per type of the environment feature amount.
(a) Type of environment feature amount
(b) Example of sensing data used to extract feature amounts
(c) Example of sensing processing
(d) Example of behavior to be determined and executed

First, data illustrated in FIG. 30, that is, the type of the environment feature amount extracted by the environment/body feature extraction unit 121 is

### (1) Type of Environment Feature Amount=Material Quality of Floor Surface

A processing example in this case will be described.

When the type of the environment feature amount extracted by the environment/body feature extraction unit 121 is
(a) Type of environment feature amount=material quality of floor surface,
(b) the sensor detection values of the vibration sensor such as the IMU, the voice sensors, the joint angle sensors, or the joint torque sensors are used as sensing data used to extract the feature amounts.

Furthermore, as (c) example of sensing processing at a time when each sensing data indicated in above (b) is acquired, for example, following sensing processing is used.
(c1) Sense at time of walking
(c2) Interact with and sense (jump on, hit, and stroke) floor surface
(c3) Sense vibration/sound caused by people/object/robot in surroundings, and floor surface

Furthermore, examples of (d) behavior to be determined and executed include following behaviors.
(d1) Correct odometry
(d2) Change gait
(d3) Change walking mode
(d4) Play using slip of floor surface
(d5) Play using hardness of floor surface

A reason to “(d1) correct odometry” is that a movement amount changes due to a difference in the friction force of the floor surface.

A reason to “(d2) change gait” is that the robot has a different appropriate gait depending on the friction force of the floor surface. Furthermore, this reason also includes that the robot readily tumbles on the floor surface of a high friction force, and, moreover, walking at a high speed on a hard floor surface is noisy and therefore the robot needs to slowly walk.

A specific example of “(d3) change walking mode” includes, for example, moving while slipping like skating at a slippery place.

A specific example of “(d4) play using slip of floor surface” includes performing, for example, a behavior of slipping an object and playing while slipping by itself.

A specific example of “(d5) play using hardness of floor surface” includes, for example, performing tap dance.

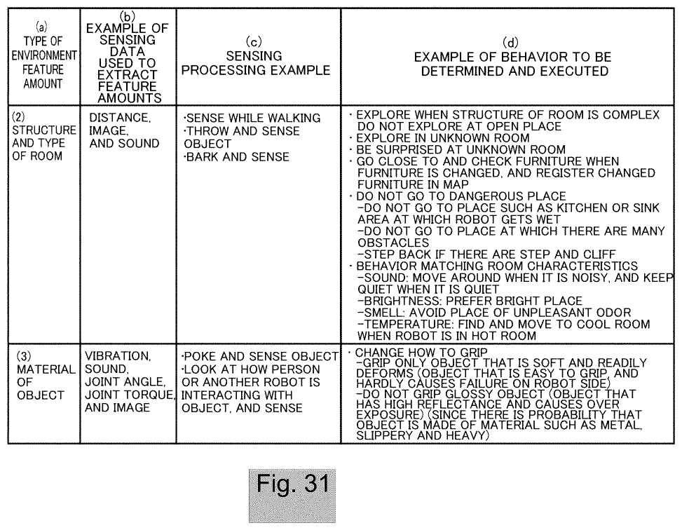

Next, data illustrated in FIG. 31, that is, the type of the environment feature amount extracted by the environment/body feature extraction unit 121 is

### (2) Type of Environment Feature Amount=Structure and Type of Room

A processing example in this case will be described.

When the type of the environment feature amount extracted by the environment/body feature extraction unit 121 is
(a) Type of environment feature amount=structure and type of room,
(b) the sensor detection values of the distance sensor, the image sensor, the voice sensors, or the like are used as sensing data used to extract the feature amounts.

Furthermore, as (c) example of sensing processing at a time when each sensing data indicated in above (b) is acquired, for example, following sensing processing is used.
(c1) Sense while walking
(c2) Throw and sense object (e.g., detect whether object disappears or does not disappear from captured image of image sensor (camera))
(c3) Bark and sense (acquire and analyze a reverberating echo using voice sensors (microphones) and analyze distances to objects in surroundings)

Furthermore, examples of (d) behavior to be determined and executed include following behaviors.
(d1) Explore when structure of room is complex
(d2) Explore in unknown room
(d3) Be surprised at unknown room
(d4) Go close to and check furniture when furniture is changed, and register changed furniture in map
(d5) Do not go to dangerous place
(d6) Behave in accordance with characteristics of room

A specific example of “(d1) explore when structure of room is complex” includes, for example, processing of causing the robot 100 to walk around in the room. Note that the robot 100 may be set only to look around without exploring at an open place.

A specific example of “(d5) Do not go to dangerous place” includes behaviors of not going to a place such as a kitchen or a sink area at which the robot gets wet, not going to a place at which there are many obstacles, and, moreover, stepping back when there is a step/cliff.

A specific example of “(d6) behave in accordance with characteristics of room” includes, for example, moving around in a noisy room, and keeping quiet in a quiet room.

The specific example includes moving to a room whose brightness is high.

As for an odor, the specific example includes avoiding a room of an unpleasant odor. As for the temperature, the specific example includes moving from a hot room to a cool room.

The specific examples include these behaviors.

Next, the data illustrated in FIG. 31, that is, the type of the environment feature amount extracted by the environment/body feature extraction unit 121 is

### (3) Type of Environment Feature Amount=Material of Object

A processing example in this case will be described.

When the type of the environment feature amount extracted by the environment/body feature extraction unit 121 is
(a) Type of environment feature amount=material of object,
the sensor detection values of the vibration sensor such as the IMU, the voice sensors, the joint angle sensors, the joint torque sensors, the image sensor, or the like are used as sensing data used to extract the feature amounts.

Furthermore, as (c) example of sensing processing at a time when each sensing data indicated in above (b) is acquired, for example, following sensing processing is used.
(c1) Poke and sense object
(c2) Sense how person or another robot, and object interact (acquire, for example, captured image of image sensor (camera))

Furthermore, examples of (d) behavior to be determined and executed include following behaviors.
(d1) Change how to grip object (gripping mode)

More specifically, for example, the robot grips only an object that is soft and readily deforms.

This is processing of selecting and gripping an object that is easy to grip and hardly causes a failure on the robot side.

Furthermore, the robot does not grip a glossy object (an object that has high reflectance and causes over exposure).

This is because there is a probability that the object is made of a material such as a metal, slippery, and heavy.

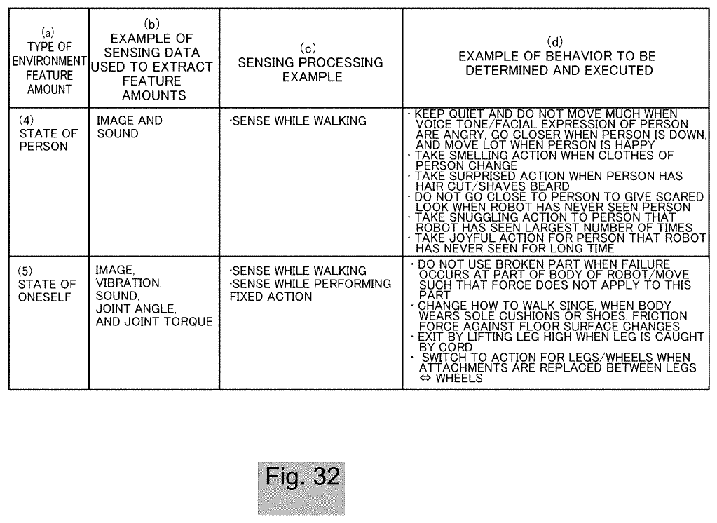

Next, the data illustrated in FIG. 32, that is, the type of the environment feature amount extracted by the environment/body feature extraction unit 121 is

### (4) Type of Environment Feature Amount=State of People

A processing example in this case will be described.

When the type of the environment feature amount extracted by the environment/body feature extraction unit 121 is
(a) Type of environment feature amount=state of people,
(b) the sensor detection values of the image sensor, the voice sensors, or the like are used as sensing data used to extract the feature amounts.

Furthermore, as (c) example of sensing processing at a time when each sensing data indicated in above (b) is acquired, for example, following sensing processing is used.
(c1) Sense while walking

Furthermore, examples of (d) behavior to be determined and executed include following behaviors.
(d1) Stay still and do not move much when voice tone or facial expression of person is angry, go close to person when person is down, and move lot when person is happy
(d2) Take smelling action when clothes of person change
(d3) Take surprised action when person has hair cut or shaves beard
(d4) Do not go close to person to give scared look when robot has never seen person
(d5) Take snuggling action to person that robot has seen largest number of times
(d6) Take joyful action for person that robot has never seen for long time

Next, the data illustrated in FIG. 32, that is, the type of the environment feature amount extracted by the environment/body feature extraction unit 121 is

### (5) Type of Environment Feature Amount=State of Oneself (Robot)

A processing example in this case will be described.

When the type of the environment feature amount extracted by the environment/body feature extraction unit 121 is
(a) Type of environment feature amount=state of oneself (robot),
(b) the sensor detection values of the image sensor, the vibration sensor such as the IMU, the voice sensors, the joint angle sensors, the joint torque sensors, or the like are used as sensing data used to extract the feature amounts.

Furthermore, as (c) example of sensing processing at a time when each sensing data indicated in above (b) is acquired, for example, following sensing processing is used.
(c1) Sense at time of walking
(c2) Take fixed action and sense

Furthermore, examples of (d) behavior to be determined and executed include following behaviors.
(d1) Do not use broken part when failure occurs at part of body of robot.

Alternatively, move such that force does not apply to this part.
(d2) Change how to walk since, when body wears sole cushions or shoes, friction force against floor surface changes
(d3) Exit by lifting leg high when leg is caught by cord
(d4) Switch to action that supports attachments such as replaced wheels when legs are replaced with attachments such as wheels

As described above, the robot (information processing device) 100 according to the present disclosure determines and executes various optimal behaviors according to the types of the environment feature amounts extracted by the environment/body feature extraction unit 121.

### 6. HARDWARE CONFIGURATION EXAMPLE OF ROBOT (INFORMATION PROCESSING DEVICE) ACCORDING TO PRESENT DISCLOSURE

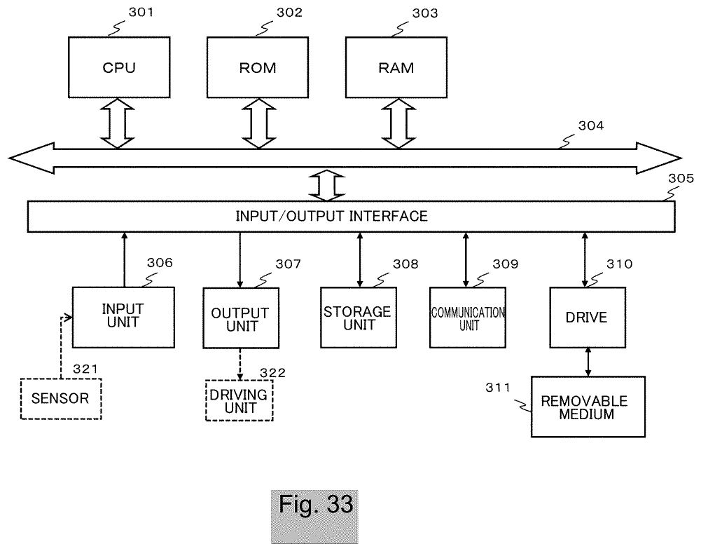

Next, a hardware configuration example of the robot (information processing device) 100 according to the present disclosure will be described with reference to FIG. 33. The hardware configuration illustrated in FIG. 33 will be described.

A Central Processing Unit (CPU) 301 functions as a data processing unit that executes various types of processing according to programs stored in a Read Only Memory (ROM) 302 or a storage unit 308. For example, the processing according to the sequence described in the above embodiment is executed. A Random Access Memory (RAM) 303 stores a program that is executed by the CPU 301 or data. The CPU 301, the ROM 302, and the RAM 303 are connected to each other by a bus 304.

The CPU 301 is connected to an input/output interface 305 via the bus 304, and the input/output interface 305 is connected with an input unit 306 including various switches, a touch panel, and a microphone and, in addition, a user input unit, a sensor detection value acquisition unit of various sensors 321 such as cameras and microphones, and the like, and an output unit 307 including displays, speakers, and the like.

Furthermore, the output unit 307 outputs driving information for a driving unit 322, too.

The CPU 301 receives an input of a command, situation data, and the like input from the input unit 306, executes various types of processing, and outputs processing results to the output unit 307, for example.

The storage unit 308 connected to the input/output interface 305 is formed of, for example, a hard disk or the like, and stores a program executed by the CPU 301 and various items of data. A communication unit 309 functions as a transmission/reception unit for data communication via a network such as the Internet or a local area network, and communicates with an external device. Furthermore, in addition to the CPU, there may be provided a Graphics Processing Unit (GPU) as a dedicated processing unit for image information input from the cameras.

A drive 310 connected to the input/output interface 305 drives a removable medium 311 such as a magnetic disk, an optical disc, a magneto-optical disc, or a semiconductor memory such as a memory card to record or read data.

### 7. SUMMARY OF CONFIGURATION OF PRESENT DISCLOSURE

The embodiment of the present disclosure has been described above in detail with reference to the specific embodiment. However, it will be apparent to those skilled in the art that modification and substitution of the embodiment can be made without departing from the gist of the present disclosure. That is, the present invention has been disclosed according to an illustrative form, but the present disclosure should not be restrictively construed. The gist of the present disclosure should be determined in consideration of the claims.

Note that the technology disclosed in this description can have the following configuration.

(1) An information processing device includes:
an environment/body feature extraction unit that receives an input of a detection value of a sensor attached to a robot, and extracts at least any one feature amount of an environment feature amount that is a feature amount related to an environment around the robot, and a body feature amount that is a feature amount related to the robot itself; and
a behavior control unit that determines and executes a behavior to be executed by the robot based on the feature amount extracted by the environment/body feature extraction unit.

(2) According to the information processing device described in (1),
the information processing device causes the robot to execute a behavior for acquiring the detection value of the sensor, and executes active sensor detection value acquisition processing.

(3) In the information processing device described in any one of (1) and (2), the environment/body feature extraction unit applies a machine learning model, and extracts the environment feature amount that is the feature amount related to the environment around the robot or the body feature amount that is the feature amount related to the robot itself based on the detection value of the sensor.

(4) In the information processing device described in any one of (1) to (3), the environment/body feature extraction unit extracts as the environment feature amount a feature amount of at least any one of material quality, hardness, and slipperiness of a floor surface on which the robot exists.

(5) In the information processing device described in any one of (1) to (4), the environment/body feature extraction unit extracts as the body feature amount a feature amount indicating whether or not an accessory is equipped by the robot.

(6) In the information processing device described in any one of (1) to (5), the behavior control unit determines at least any one behavior of a movement behavior, a gripping behavior, an environment adaptation behavior, feeling expression, and a conduct of the robot based on the feature amount extracted by the environment/body feature extraction unit.

(7) In the information processing device described in any one of (1) to (6), the behavior control unit determines a walking mode of the robot based on the feature amount extracted by the environment/body feature extraction unit.

(8) In the information processing device described in any one of (1) to (7), the behavior control unit determines at least any one of a walking speed and a stride of the robot based on the feature amount extracted by the environment/body feature extraction unit.

(9) In the information processing device described in any one of (1) to (8), the behavior control unit determines an action that the robot needs to execute, based on the feature amount extracted by the environment/body feature extraction unit, and causes the robot to execute the determined action.

(10) In the information processing device described in any one of (1) to (9), the behavior control unit executes processing of determining a facial expression of the robot based on the feature amount extracted by the environment/body feature extraction unit, and causing the robot to change the facial expression thereof into the determined facial expression.

(11) In the information processing device described in any one of (1) to (10), the behavior control unit includes
a behavior determination unit that determines a behavior to be executed by the robot based on the feature amount extracted by the environment/body feature extraction unit, and
a behavior execution unit that causes the robot to execute the behavior determined by the behavior determination unit.

(12) In the information processing device described in (11), the behavior control unit further includes a behavior switching control unit that performs behavior switching control when the behavior determined by the behavior determination unit is different from a behavior currently executed by the robot.

(13) The information processing device described in any one of (1) to (12) further includes a sensing database that holds the detection value of the sensor, and the environment/body feature extraction unit compares a sensor detection value at a current point of time and a past sensor detection value stored in the sensing database, and determines whether the environment around the robot is a previously experienced environment or a new environment.

(14) The information processing device described in any one of (1) to (13) further includes an environment/body feature amount database that stores at least any one of the environment feature amount and the body feature amount extracted by the environment/body feature extraction unit, and
the behavior control unit
compares an environment feature amount or a body feature amount at a current point of time, and a past environment feature amount or body feature amount stored in the environment/body feature amount database, and
detects at least any one change of a change of the environment around the robot and a change of the robot itself based on a comparison result, and determines and executes an optimal behavior matching the detected change.

(15) An information processing method executed by an information processing device includes:
an environment/body feature extraction step of, at an environment/body feature extraction unit, receiving an input of a detection value of a sensor attached to a robot, and extracting at least any one feature amount of an environment feature amount that is a feature amount related to an environment around the robot, and a body feature amount that is a feature amount related to the robot itself; and
a behavior control step of, at a behavior control unit, determining and executing a behavior to be executed by the robot based on the feature amount extracted by the environment/body feature extraction unit.

(16) A program that causes an information processing device to execute information processing, causing:
an environment/body feature extraction unit to execute an environment/body feature extraction step of receiving an input of a detection value of a sensor attached to a robot, and extracting at least any one feature amount of an environment feature amount that is a feature amount related to an environment around the robot, and a body feature amount that is a feature amount related to the robot itself; and
a behavior control unit to execute a behavior control step of determining and executing a behavior to be executed by the robot based on the feature amount extracted by the environment/body feature extraction unit.

Furthermore, the series of processing described in this description can be executed by hardware, software, or a composite configuration of both. If the series of processing is to be executed by software, the series of processing can be executed by installing a program recording the processing sequence into a memory in a computer embedded in dedicated hardware, or by installing the program into a general-purpose computer capable of executing various kinds of processing. For example, the program can be pre-recorded on a recording medium. Rather than being installed into a computer from a recording medium, the program can be received via a network such as a Local Area Network (LAN) or the Internet, and installed into a built-in recording medium such as a hard disk.

Note that the various processing described in this description can be performed consecutively in the described order or may be executed in parallel or individually depending on the processing capability of the device performing the processing or as needed. Furthermore, in this description, the system is a logical set of configurations of a plurality of devices, and the devices having each configuration are not limited to those in the same housing.

### INDUSTRIAL APPLICABILITY

As described above, the configuration according to one embodiment of the present disclosure implements a configuration that enables a robot to autonomously execute an optimal behavior matching a surrounding environment of the robot or a state of the robot itself.

More specifically, the configuration includes, for example, an environment/body feature extraction unit that receives an input of detection values of sensors attached to a robot, and extracts at least any one feature amount of environment feature amounts that are feature amounts related to an environment around the robot, and body feature amounts that are feature amounts related to the robot itself, and a behavior control unit that determines and executes a behavior to be executed by the robot based on the extracted feature amounts. The configuration acquires, for example, slipperiness of a floor as the environment feature amount, and, when the floor is slippery, determines and executes an optimal behavior that matches the feature amounts and executes walking at a lowered walking speed or the like. This configuration implements the configuration that enables the robot to autonomously execute an optimal behavior matching the surrounding environment of the robot or the state of the robot itself.

### REFERENCE SIGNS LIST

100 Robot (information processing device)
110 Sensing unit
120 Data processing unit
121 Environment/feature extraction unit
122 Behavior control unit
123 Behavior determination unit
124 Behavior switching control unit
125 Behavior execution unit
126 Action control unit
127 Facial expression control unit
131 Sensing data database
132 Environment/feature amount database
151 Clothes (accessory)
152 Shoe (accessory)
153 Sole pad (accessory)
301 CPU
302 ROM
303 RAM
304 Bus
305 Input/output interface
306 Input unit
307 Output unit
308 Storage unit
309 Communication unit
310 Drive
311 Removable medium
321 Sensor
322 Driving portion

1. An information processing device comprising:
an environment/body feature extraction unit that receives an input of a detection value of a sensor attached to a robot, and extracts at least any one feature amount of an environment feature amount that is a feature amount related to an environment around the robot, and a body feature amount that is a feature amount related to the robot itself; and
a behavior control unit that determines and executes a behavior to be executed by the robot based on the feature amount extracted by the environment/body feature extraction unit.

2. The information processing device according to claim 1, wherein the information processing device
causes the robot to execute a behavior for acquiring the detection value of the sensor, and executes active sensor detection value acquisition processing.

3. The information processing device according to claim 1, wherein the environment/body feature extraction unit applies a machine learning model, and extracts the environment feature amount that is the feature amount related to the environment around the robot or the body feature amount that is the feature amount related to the robot itself based on the detection value of the sensor.

4. The information processing device according to claim 1, wherein the environment/body feature extraction unit extracts as the environment feature amount a feature amount of at least any one of material quality, hardness, and slipperiness of a floor surface on which the robot exists.

5. The information processing device according to claim 1, wherein the environment/body feature extraction unit extracts as the body feature amount a feature amount indicating whether or not an accessory is equipped by the robot.

6. The information processing device according to claim 1, wherein the behavior control unit determines at least any one behavior of a movement behavior, a gripping behavior, an environment adaptation behavior, feeling expression, and a conduct of the robot based on the feature amount extracted by the environment/body feature extraction unit.

7. The information processing device according to claim 1, wherein the behavior control unit determines a walking mode of the robot based on the feature amount extracted by the environment/body feature extraction unit.

8. The information processing device according to claim 1, wherein the behavior control unit determines at least any one of a walking speed and a stride of the robot based on the feature amount extracted by the environment/body feature extraction unit.

9. The information processing device according to claim 1, wherein the behavior control unit determines an action that the robot needs to execute, based on the feature amount extracted by the environment/body feature extraction unit, and causes the robot to execute the determined action.

10. The information processing device according to claim 1, wherein the behavior control unit executes processing of determining a facial expression of the robot based on the feature amount extracted by the environment/body feature extraction unit, and causing the robot to change the facial expression thereof into the determined facial expression.

11. The information processing device according to claim 1, wherein the behavior control unit includes
a behavior determination unit that determines a behavior to be executed by the robot based on the feature amount extracted by the environment/body feature extraction unit, and
a behavior execution unit that causes the robot to execute the behavior determined by the behavior determination unit.

12. The information processing device according to claim 11, wherein the behavior control unit further includes a behavior switching control unit that performs behavior switching control when the behavior determined by the behavior determination unit is different from a behavior currently executed by the robot.

13. The information processing device according to claim 1, further comprising a sensing database that holds the detection value of the sensor,
wherein the environment/body feature extraction unit compares a sensor detection value at a current point of time and a past sensor detection value stored in the sensing database, and determines whether the environment around the robot is a previously experienced environment or a new environment.

14. The information processing device according to claim 1, further comprising an environment/body feature amount database that stores at least any one of the environment feature amount and the body feature amount extracted by the environment/body feature extraction unit,
wherein the behavior control unit
compares an environment feature amount or a body feature amount at a current point of time, and a past environment feature amount or body feature amount stored in the environment/body feature amount database, and
detects at least any one change of a change of the environment around the robot and a change of the robot itself based on a comparison result, and determines and executes an optimal behavior matching the detected change.

15. An information processing method that is executed by an information processing device comprising:
an environment/body feature extraction step of, at an environment/body feature extraction unit, receiving an input of a detection value of a sensor attached to a robot, and extracting at least any one feature amount of an environment feature amount that is a feature amount related to an environment around the robot, and a body feature amount that is a feature amount related to the robot itself; and
a behavior control step of, at a behavior control unit, determining and executing a behavior to be executed by the robot based on the feature amount extracted by the environment/body feature extraction unit.

16. A program that causes an information processing device to execute information processing, causing:
an environment/body feature extraction unit to execute an environment/body feature extraction step of receiving an input of a detection value of a sensor attached to a robot, and extracting at least any one feature amount of an environment feature amount that is a feature amount related to an environment around the robot, and a body feature amount that is a feature amount related to the robot itself; and
a behavior control unit to execute a behavior control step of determining and executing a behavior to be executed by the robot based on the feature amount extracted by the environment/body feature extraction unit.
